(19) United States
(12) Patent Application Publication
(10) Pub. No.: US 2025/0175944 A1
(43) Pub. Date: May 29, 2025

(54) TECHNIQUES FOR PAGING IN A NON-TERRESTRIAL NETWORK

(71) Applicant: QUALCOMM Incorporated, San Diego, CA (US)

(72) Inventors: Ansah Ahmed SHEIK, Hyderabad (IN); Rishika TINDOLA, Hyderabad (IN); Mitul VOHRA, Hyderabad (IN)

(21) Appl. No.: 18/520,399

(22) Filed: Nov. 27, 2023

(51) Int. Cl. H04W 68/02; H04W 68/00; H04W 84/06

(52) U.S. Cl. CPC H04W 68/02; H04W 68/005; H04W 84/06

(57) ABSTRACT

Methods, systems, and devices for wireless communication are described. A UE may perform a dual registration with a geostationary orbit (GSO) entity of an NTN (NTN) and a non-GSO (NGSO) entity, where a GSO cell of the GSO entity may include an NGSO cell of the NGSO entity. The UE may receive paging from the GSO entity while in the NGSO cell, or after leaving the NGSO cell, based on registering with the GSO entity and the NGSO entity. For example, the UE may receive paging from the GSO entity based on switching a secondary receiver of the UE from monitoring a communication link associated with the NGSO entity to monitoring a communication link associated with the GSO entity. In some cases, the UE may skip performing a tracking area update (TAU) when entering a new tracking area (TA), leaving an NGSO cell, or entering a new NGSO cell.

### FIELD OF TECHNOLOGY

The following relates to wireless communication, including techniques for paging in a non-terrestrial network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for paging in a non-terrestrial network (NTN). For example, the described techniques may provide for a user equipment (UE) to camp on a first network associated with a first entity (such as a non-geostationary orbit (NGSO) network associated with NGSO entity), to identify a second entity (such as a geostationary orbit (GSO) entity), and perform dual registration with the NGSO entity and the GSO entity (e.g., to register with a GSO entity and an NGSO entity). A GSO cell served by the GSO entity may include one or more NGSO cells served by one or more NGSO entities (e.g., the UE may move across various NGSO tracking areas while remaining in a same GSO tracking area). The UE may perform tracking area updates (TAUs) through the GSO entity (e.g., while also maintaining a connection with the NGSO entity), and may shift to the GSO network. The UE may switch one or more receivers to the GSO entity, and may monitor for and receive paging from the GSO entity while in the NGSO cell, or after leaving the NGSO cell, based on registering with the GSO entity and the NGSO entity.

Additionally, or alternatively, the UE may conserve power by performing TAUs and monitoring for paging with reference to the GSO entity (e.g., instead of performing multiple TAUs associated with a change in a location of the UE with respect to the NGSO entity) based on registering with the GSO entity. For example, the UE may register with the NGSO entity and the GSO entity based on being in an NGSO cell served by the NGSO entity and in a GSO cell served by the GSO entity. The UE may leave the NGSO cell served by the NGSO entity (e.g., enter a tracking area (TA) associated with a tracking area code (TAC) not indicated by a tracking area identity (TAI) list of the NGSO entity), and may receive paging from the GSO entity after leaving the NGSO cell without performing another TAU.

Additionally, or alternatively, the UE may monitor paging occasions (POs) associated with the GSO entity via a second receiver (e.g., receiving chain, secondary receiver) of the UE, while the UE may monitor for communications from the NGSO entity via a first receiver (e.g., receiving chain, primary receiver) of the UE. In some cases, the GSO entity may receive pages (e.g., paging signaling) from the NGSO entity that are for the UE, and may transmit (e.g., forward) the pages to the UE based on the TAC associated with the UE being in the TAI list of the GSO. The UE may receive pages while performing less TAUs, using less communication resources, expending less power, and decreasing overhead signaling for the wireless system.

A method for wireless communication by a UE is described. The method may include establishing a first communication link with a first NTN, at least a first receiver of a set of receivers of the UE corresponding to the first communication link, establishing a second communication link with a second NTN based on registering with the second NTN, the registering being based on one or more measurements associated with a network availability of the second NTN, monitoring the second communication link for paging signaling from the second NTN via a second receiver of the set of receivers of the UE, and receiving the paging signaling from the second NTN based on monitoring the second communication link for the paging signaling.

A UE for wireless communication is described. The UE may include one or more memories storing processor executable code, and one or more processors coupled with the one or more memories. The one or more processors may individually or collectively operable to execute the code to cause the UE to establish a first communication link with a first NTN, at least a first receiver of a set of receivers of the UE corresponding to the first communication link, establish a second communication link with a second NTN based on registering with the second NTN, the registering being based on one or more measurements associated with a network availability of the second NTN, monitor the second communication link for paging signaling from the second NTN via a second receiver of the set of receivers of the UE, and receive the paging signaling from the second NTN based on monitoring the second communication link for the paging signaling.

Another UE for wireless communication is described. The UE may include means for establishing a first communication link with a first NTN, at least a first receiver of a set of receivers of the UE corresponding to the first communication link, means for establishing a second communication link with a second NTN based on registering with the second NTN, the registering being based on one or more measurements associated with a network availability of the second NTN, means for monitoring the second communication link for paging signaling from the second NTN via a second receiver of the set of receivers of the UE, and means for receiving the paging signaling from the second NTN based on monitoring the second communication link for the paging signaling.

A non-transitory computer-readable medium storing code for wireless communication is described. The code may include instructions executable by one or more processors to establish a first communication link with a first NTN, at least a first receiver of a set of receivers of the UE corresponding to the first communication link, establish a second communication link with a second NTN based on registering with the second NTN, the registering being based on one or more measurements associated with a network availability of the second NTN, monitor the second communication link for paging signaling from the second NTN via a second receiver of the set of receivers of the UE, and receive the paging signaling from the second NTN based on monitoring the second communication link for the paging signaling.

Some examples of the method, UEs, and non-transitory computer-readable medium described herein may further include operations, features, means, or instructions for receiving, via the second communication link, control signaling indicating a set of POs for the paging signaling from the second NTN, where the set of POs at least partially overlaps with one or more POs corresponding to the first communication link with the first NTN, and where the monitoring may be based on the control signaling indicating the set of POs.

Some examples of the method, UEs, and non-transitory computer-readable medium described herein may further include operations, features, means, or instructions for receiving, via the second communication link, control signaling indicating a set of POs for the paging signaling from the second NTN, where the set of POs may be different than one or more POs corresponding to the first communication link with the first NTN, and where the monitoring may be based on the control signaling indicating the set of POs.

Some examples of the method, UEs, and non-transitory computer-readable medium described herein may further include operations, features, means, or instructions for switching the second receiver from the first communication link to the second communication link, where monitoring the second communication link for the paging signaling may be based on the switching.

Some examples of the method, UEs, and non-transitory computer-readable medium described herein may further include operations, features, means, or instructions for receiving control signaling indicating information associated with the second NTN including a satellite type of the second NTN, one or more resources for communications with the second NTN, or one or more locations associated with the second NTN, or any combination thereof, where registering with the second NTN may be based on the control signaling indicating the information associated with the second NTN.

In some examples of the method, UEs, and non-transitory computer-readable medium described herein, receiving the control signaling indicating the information associated with the second NTN may include operations, features, means, or instructions for receiving a system information block.

Some examples of the method, UEs, and non-transitory computer-readable medium described herein may further include operations, features, means, or instructions for performing the one or more measurements associated with the network availability of the second NTN, where the one or more measurements include a public land mobile network search, or decoding one or more non-terrestrial network measurement configurations broadcasted by the second NTN, or both.

Some examples of the method, UEs, and non-transitory computer-readable medium described herein may further include operations, features, means, or instructions for storing, in a database, a mapping between one or more locations and the first NTN, the second NTN, or both, where registering with the second NTN may be based on the mapping.

Some examples of the method, UEs, and non-transitory computer-readable medium described herein may further include operations, features, means, or instructions for transmitting uplink signaling to the first NTN or the second NTN based on receiving the paging signaling, a service type associated with the UE, a quality of service measurement associated with the second NTN, or a wireless communication throughput associated with the UE, or any combination thereof.

Some examples of the method, UEs, and non-transitory computer-readable medium described herein may further include operations, features, means, or instructions for receiving control signaling indicating one or more parameters including an indication that the first NTN or the second NTN may be a default non-terrestrial network device, a service type associated with the first NTN, a service type associated with the second NTN, a service type associated with the first NTN and the second NTN, or a throughput threshold, or any combination thereof and transmitting uplink signaling to the first NTN or the second NTN based on receiving the paging signaling and the one or more parameters.

Some examples of the method, UEs, and non-transitory computer-readable medium described herein may further include operations, features, means, or instructions for receiving control signaling from the second NTN triggering a handover for the UE from the second NTN to the first NTN based on a service type associated with the UE, a quality of service measurement associated with the second NTN, a wireless communication throughput associated with the UE, or a reference signal receive power (RSRP) associated with the first NTN, or any combination thereof and switching the second receiver from the second communication link to the first communication link based on receiving the control signaling.

Some examples of the method, UEs, and non-transitory computer-readable medium described herein may further include operations, features, means, or instructions for switching the first receiver from the first communication link to the second communication link based on determining a discontinuous coverage associated with at least the first NTN and monitoring the second communication link for the paging signaling via the first receiver, or the second receiver, or both.

Some examples of the method, UEs, and non-transitory computer-readable medium described herein may further include operations, features, means, or instructions for operating in a deep sleep mode for a time duration based on registering with the second NTN, a first mobility associated with the UE satisfying a first mobility threshold, or a second mobility associated with the first NTN satisfying a second mobility threshold, or any combination thereof and transmitting, after the time duration, an indication of a TA associated with the UE based on a change in the TA.

In some examples of the method, UEs, and non-transitory computer-readable medium described herein, registering with the second NTN may include operations, features, means, or instructions for transmitting control signaling indicating a TA associated with the UE.

In some examples of the method, UEs, and non-transitory computer-readable medium described herein, the first NTN includes a NGSO satellite and the second NTN includes a GSO satellite.

Some examples of the method, UEs, and non-transitory computer-readable medium described herein may further include operations, features, means, or instructions for receiving data signaling, control signaling, or both, via the first receiver based on the first receiver including a primary receiver of the UE, where the UE receives the paging signaling via the second receiver based on the second receiver including a secondary receiver of the UE.

A method for wireless communication by a first NTN is described. The method may include establishing a communication link with a UE associated with a TA corresponding to a first cell served by the first NTN, transmitting data signaling to the UE via the communication link based on the TA, and transmitting paging signaling to the UE via a second NTN that serves a second cell corresponding to a set of TAs based on the set of TAs including the TA.

A first NTN for wireless communication is described. The first NTN may include one or more memories storing processor executable code, and one or more processors coupled with the one or more memories. The one or more processors may individually or collectively operable to execute the code to cause the first NTN to establish a communication link with a UE associated with a TA corresponding to a first cell served by the first NTN, transmit data signaling to the UE via the communication link based on the TA, and transmit paging signaling to the UE via a second NTN that serves a second cell corresponding to a set of TAs based on the set of TAs including the TA.

Another first NTN for wireless communication is described. The first NTN may include means for establishing a communication link with a UE associated with a TA corresponding to a first cell served by the first NTN, means for transmitting data signaling to the UE via the communication link based on the TA, and means for transmitting paging signaling to the UE via a second NTN that serves a second cell corresponding to a set of TAs based on the set of TAs including the TA.

A non-transitory computer-readable medium storing code for wireless communication is described. The code may include instructions executable by one or more processors to establish a communication link with a UE associated with a TA corresponding to a first cell served by the first NTN, transmit data signaling to the UE via the communication link based on the TA, and transmit paging signaling to the UE via a second NTN that serves a second cell corresponding to a set of TAs based on the set of TAs including the TA.

In some examples of the method, first nons, and non-transitory computer-readable medium described herein, communicating the paging signaling may include operations, features, means, or instructions for transmitting the paging signaling to the second NTN for forwarding to the UE via a second communication link between the UE and the second NTN.

Some examples of the method, first nons, and non-transitory computer-readable medium described herein may further include operations, features, means, or instructions for transmitting control signaling indicating information associated with the second NTN including a satellite type of the second NTN, one or more resources for communications with the second NTN, or one or more locations associated with the second NTN, or any combination thereof, where communicating the paging signaling with the UE may be based on the control signaling indicating the information associated with the second NTN.

In some examples of the method, first nons, and non-transitory computer-readable medium described herein, transmitting the control signaling indicating the information associated with the second NTN may include operations, features, means, or instructions for transmitting a system information block.

In some examples of the method, first nons, and non-transitory computer-readable medium described herein, the first NTN includes a NGSO satellite and the second NTN includes a GSO satellite.

A method for wireless communication by a second NTN is described. The method may include establishing a communication link with a UE based on a registration of the UE with the second NTN, the UE being associated with a TA, receiving paging signaling from a first NTN based on the registration and the first NTN serving a first cell corresponding to the TA, and transmitting the paging signaling to the UE via the communication link based on the second NTN serving a second cell corresponding to a set of TAs including the TA.

A second NTN for wireless communication is described. The second NTN may include one or more memories storing processor executable code, and one or more processors coupled with the one or more memories. The one or more processors may individually or collectively operable to execute the code to cause the second NTN to establish a communication link with a UE based on a registration of the UE with the second NTN, the UE being associated with a TA, receive paging signaling from a first NTN based on the registration and the first NTN serving a first cell corresponding to the TA, and transmit the paging signaling to the UE via the communication link based on the second NTN serving a second cell corresponding to a set of TAs including the TA.

Another second NTN for wireless communication is described. The second NTN may include means for establishing a communication link with a UE based on a registration of the UE with the second NTN, the UE being associated with a TA, means for receiving paging signaling from a first NTN based on the registration and the first NTN serving a first cell corresponding to the TA, and means for transmitting the paging signaling to the UE via the communication link based on the second NTN serving a second cell corresponding to a set of TAs including the TA.

A non-transitory computer-readable medium storing code for wireless communication is described. The code may include instructions executable by one or more processors to establish a communication link with a UE based on a registration of the UE with the second NTN, the UE being associated with a TA, receive paging signaling from a first NTN based on the registration and the first NTN serving a first cell corresponding to the TA, and transmit the paging signaling to the UE via the communication link based on the second NTN serving a second cell corresponding to a set of TAs including the TA.

In some examples of the method, UEs, NTN entities, and non-transitory computer-readable medium described herein, transmitting the paging signaling may include operations, features, means, or instructions for transmitting the paging signaling in at least one PO of a set of POs that at least partially overlaps with one or more POs corresponding to the first NTN.

In some examples of the method, UEs, NTN entities, and non-transitory computer-readable medium described herein, transmitting the paging signaling may include operations, features, means, or instructions for transmitting the paging signaling in at least one PO of a set of POs that may be different than one or more POs corresponding to the first NTN.

Some examples of the method, UEs, NTN entities, and non-transitory computer-readable medium described herein may further include operations, features, means, or instructions for receiving uplink signaling from the UE based on transmitting the paging signaling, a quality of service measurement associated with the second NTN, or a wireless communication throughput associated with the UE, or any combination thereof.

Some examples of the method, UEs, NTN entities, and non-transitory computer-readable medium described herein may further include operations, features, means, or instructions for transmitting control signaling indicating one or more parameters including an indication that the first NTN or the second NTN may be a default non-terrestrial network device, a service type associated with the first NTN, a service type associated with the second NTN, a service type associated with the first NTN entity and the second NTN, or a throughput threshold, or any combination thereof and receiving uplink signaling from the UE based on transmitting the paging signaling, and the one or more parameters.

Some examples of the method, UEs, NTN entities, and non-transitory computer-readable medium described herein may further include operations, features, means, or instructions for transmitting control signaling triggering a handover for the UE from the second NTN to the first NTN based on a service type associated with the UE, a quality of service measurement associated with the second NTN, a wireless communication throughput associated with the UE, or a RSRP associated with the first NTN, or any combination thereof.

Some examples of the method, UEs, NTN entities, and non-transitory computer-readable medium described herein may further include operations, features, means, or instructions for transmitting the control signaling may be based on the RSRP satisfying the RSRP threshold.

In some examples of the method, UEs, NTN entities, and non-transitory computer-readable medium described herein, the first NTN includes a NGSO satellite and the second NTN includes a GSO satellite.

### BRIEF DESCRIPTION OF THE DRAWINGS

FIG. 1 shows an example of a wireless communications system that supports techniques for paging in a non-terrestrial network (NTN) in accordance with one or more aspects of the present disclosure.

FIG. 2 shows an example of a wireless communications system and paging occasion (PO) diagrams that supports techniques for paging in an NTN in accordance with one or more aspects of the present disclosure.

FIG. 3 shows an example of a process flow that supports techniques for paging in an NTN in accordance with one or more aspects of the present disclosure.

FIGS. 4 and 5 show block diagrams of devices that support techniques for paging in an NTN in accordance with one or more aspects of the present disclosure.

FIG. 6 shows a block diagram of a communications manager that supports techniques for paging in an NTN in accordance with one or more aspects of the present disclosure.

FIG. 7 shows a diagram of a system including a device that supports techniques for paging in an NTN in accordance with one or more aspects of the present disclosure.

FIGS. 8 and 9 show block diagrams of devices that support techniques for paging in an NTN in accordance with one or more aspects of the present disclosure.

FIG. 10 shows a block diagram of a communications manager that supports techniques for paging in an NTN in accordance with one or more aspects of the present disclosure.

FIG. 11 shows a diagram of a system including a device that supports techniques for paging in an NTN in accordance with one or more aspects of the present disclosure.

FIGS. 12 through 14 show flowcharts illustrating methods that support techniques for paging in an NTN in accordance with one or more aspects of the present disclosure.

### DETAILED DESCRIPTION

Some wireless communications systems may include non-terrestrial networks (NTNs), which may include NTN entities. For example, NTN entities may include geostationary orbit (GSO) entities (e.g., GSO satellites) and non-GSO (NGSO) entities (e.g., NGSO satellites). GSO entities may orbit the earth at a greater height than NGSO entities, and may thus serve cells associated with relatively larger cell sizes (e.g., larger round trip times (RTTS)) than NGSO entities. In some cases, a GSO cell may include one or more NGSO cells (e.g., a GSO entity may provide coverage to a cell (e.g., or a coverage area) large enough to encompass multiple smaller cells served by respective NGSO entities).

In some cases, a UE in an NTN may be able to move from one location to another (e.g., be mobile), and may perform tracking area updates (TAUs) with one or more NTN entities. The UE may perform the TAUs based on moving between tracking areas (TAs) (e.g., network designated geographic areas), where each cell (e.g., NGSO cell, GSO cell) may be associated with one or more TAs. For example, the UE may register with (e.g., establish a connection and operate in an IDLE mode with) an NGSO entity based on entering an NGSO cell served by the NGSO entity. The UE may receive an indication from the NGSO entity of a tracking area identity (TAI) list based on registering with the NGSO entity, where the TAI list may include one or more tracking area codes (TACs) corresponding to one or more TAs associated with the NGSO cell. For example, while the UE is in one of the one or more TAs indicated by the TAI list, the UE may not be expected to perform a TAU with the NGSO entity. In some cases, the NGSO may periodically transmit (e.g., broadcast) paging information, including pages, to devices (e.g., network entities, UEs) in the one or more TAs indicated by the TAI list. If the UE enters a new TA that is excluded from the TAI list of the NGSO entity, the UE may perform a TAU by transmitting (e.g., to the NGSO entity, to another network entity) an indication of the new TA, such that the UE may receive pages based on the new TA.

In some cases, the UE may enter an idle (e.g., deep sleep, RRC_IDLE, RRC_INACTIVE) mode, and the UE may receive pages from the NGSO entity while in the idle mode based on the UE being in a TA indicated by the TAI list of the NGSO entity. However, in some cases, the UE may perform TAUs relatively often (e.g., due to high UE mobility, due to changing NGSO entity location), and thus may expend large amounts of power (e.g., resulting in increased power expenditures, decreased battery life) and inefficiently utilize large amounts of communication resources (e.g., resulting in less efficient use of available system resources, increased signaling overhead, and decreased user experience).

According to one or more aspects of the present disclosure, a UE may be camped on an NGSO network, but may identify a GSO entity, and perform dual registration with an NGSO and a GSO (e.g., may register with a GSO entity and an NGSO entity). A GSO cell served by the GSO entity may include one or more NGSO cells served by one or more NGSO entities (e.g., the UE may move across various NGSO tracking areas while remaining in a same GSO tracking area). The UE may perform TAUs through the GSO entity (e.g., while also maintaining a connection with the NGSO entity) and may move to the GSO network. The UE may switch one or more receivers to the GSO entity and may monitor for and receive paging from the GSO entity while in the NGSO cell, or after leaving the NGSO cell, based on registering with the GSO entity and the NGSO entity.

Additionally, or alternatively, the UE may conserve power by performing TAUs and monitoring for paging with reference to the GSO entity (e.g., instead of performing multiple TAUs associated with a change in a location of the UE with respect to the NGSO entity) based on registering with the GSO entity. For example, the UE may register with the NGSO entity and the GSO entity based on being in an NGSO cell served by the NGSO entity and in a GSO cell served by the GSO entity. The UE may leave the NGSO cell served by the NGSO entity (e.g., enter a TA associated with a TAC not indicated by the TAI list of the NGSO entity), and may receive paging from the GSO entity after leaving the NGSO cell without performing another TAU.

Additionally, or alternatively, the UE may monitor paging occasions (POs) associated with the GSO entity via a second receiver (e.g., receiving chain, secondary receiver) of the UE, while the UE may monitor for communications from the NGSO entity via a first receiver (e.g., receiving chain, primary receiver) of the UE. In some cases, the GSO entity may receive pages (e.g., paging signaling) from the NGSO entity that are for the UE, and may transmit (e.g., forward) the pages to the UE based on the TAC associated with the UE being in the TAI list of the GSO. The UE may receive pages while performing less TAUs, using less communication resources, expending less power, and decreasing overhead signaling for the wireless system.

Aspects of the disclosure are initially described in the context of wireless communications systems. Aspects of the disclosure are also described in the context of process flows. Aspects of the disclosure are further illustrated by and described with reference to apparatus diagrams, system diagrams, and flowcharts that relate to techniques for paging in an NTN.

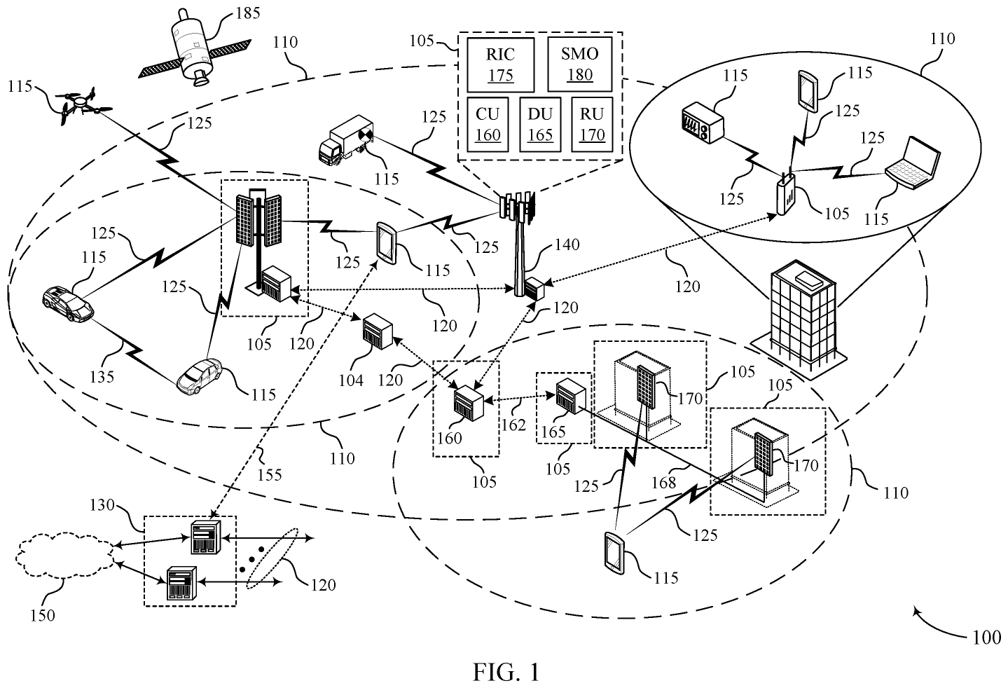

FIG. 1 shows an example of a wireless communications system 100 that supports techniques for paging in an NTN in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for paging in an NTN as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some cases, the wireless communications system 100 may include an NTN, which may include NTN entities 185. For example, the NTN entities 185 may include GSO entities (e.g., GSO satellites) and NGSO entities (e.g., NGSO satellites). GSO entities may orbit the earth at a greater height than NGSO entities and may thus serve cells associated with larger cell sizes (e.g., RTTS) than NGSO entities. In some cases, a GSO cell may include one or more NGSO cells (e.g., a GSO entity may provide coverage to a cell (e.g., or a coverage area) large enough to encompass multiple smaller cells served by respective NGSO entities). A UE 115 may be mobile and may perform TAUs each time the UE 115 enters a TA not indicated by a TAI list of an associated NTN entity 185. For example, each time a UE 115 enters an NGSO cell, the UE 115 may register with the NGSO entity serving the NGSO cell and may receive an indication of a TAI list of the NGSO entity.

According to one or more aspects of the present disclosure, a UE may be camped on an NGSO network, but may identify a GSO entity, and perform dual registration with an NGSO and a GSO (e.g., may register with a GSO entity and an NGSO entity). A GSO cell served by the GSO entity may include one or more NGSO cells served by one or more NGSO entities (e.g., the UE may move across various NGSO tracking areas while remaining in a same GSO tracking area). The UE may perform TAUs through the GSO entity (e.g., while also maintaining a connection with the NGSO entity) and may move to the GSO network. The UE may switch one or more receivers to the GSO entity and may monitor for and receive paging from the GSO entity while in the NGSO cell, or after leaving the NGSO cell, based on registering with the GSO entity and the NGSO entity.

Additionally, or alternatively, the UE may conserve power by performing TAUs and monitoring for paging with reference to the GSO entity (e.g., instead of performing multiple TAUs associated with a change in a location of the UE with respect to the NGSO entity) based on registering with the GSO entity. For example, the UE may register with the NGSO entity and the GSO entity based on being in a an NGSO cell served by the NGSO entity and in a GSO cell served by the GSO entity. The UE may leave the NGSO cell served by the NGSO entity (e.g., enter a TA associated with a TAC not indicated by the TAI list of the NGSO entity), and may receive paging from the GSO entity after leaving the NGSO cell without performing another TAU.

Additionally, or alternatively, the UE may monitor paging occasions POs associated with the GSO entity via a second receiver (e.g., receiving chain, secondary receiver) of the UE, while the UE may monitor for communications from the NGSO entity via a first receiver (e.g., receiving chain, primary receiver) of the UE. In some cases, the GSO entity may receive pages (e.g., paging signaling) from the NGSO entity that are for the UE, and may transmit (e.g., forward) the pages to the UE based on the TAC associated with the UE being in the TAI list of the GSO. Thus, the UE may receive pages while performing less TAUs, using less communication resources, expending less power, and decreasing overhead signaling for the wireless system.

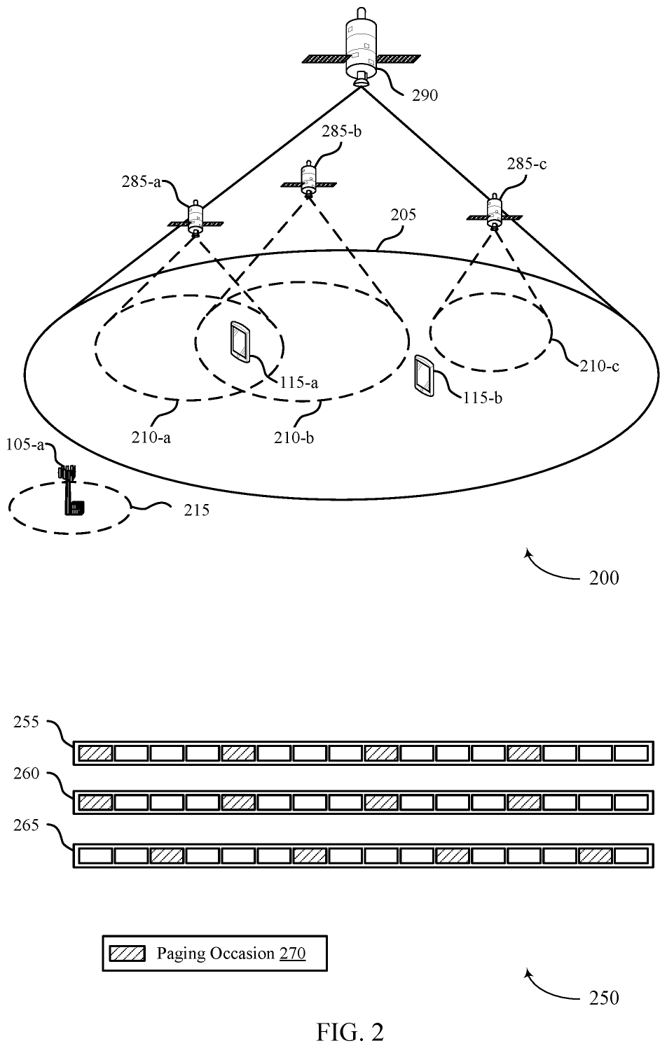

FIG. 2 shows an example of a wireless communications system 200 and PO diagrams 250 that supports techniques for paging in an NTN in accordance with one or more aspects of the present disclosure. In some cases, aspects of the wireless communications system 200 may implement or be implemented by aspects of FIG. 1. For example, the wireless communications system 200 may include NTN entities (e.g., a GSO entity 290, an NGSO entity 285-a, an NGSO entity 285-b, and an NGSO entity 285-c), a network entity 105-a, and a UE 115-a, which may be examples of the NTN entity 185, the network entities 105, and the UEs 115, respectively, as described herein with respect to FIG. 1. In some cases, the UE 115-a may receive paging from the GSO entity 290 via one or more of POs 270 based on performing a dual registration with an NGSO entity 285 and the GSO entity 290. Additionally, or alternatively, the UE 115-a may move between one or more TAs without performing TAUs based on the dual registration.

The wireless communications system 200 may include (e.g., be an example of) an NTN, which may include one or more NTN entities. In some cases, an NTN may provide coverage to one or more UEs 115 in a geographic area via one or more types of NTN entities. For example, an NTN may include one or more GSO entities (e.g., GSO satellites), one or more NGSO entities (e.g., NGSO satellites), or a mix thereof. In some cases, a cell (e.g., coverage area) served by a GSO entity may be larger (e.g., associated with a greater RTT) than a cell served by an NGSO entity, due to, for example, the GSO entity orbiting the earth at a higher altitude than the NGSO entity.

A UE may connect to and communicate with an NTN in various scenarios. For example, a UE may connect to and use an NTN when limited or no access to a terrestrial network (TN) (e.g., a TN entity) is available to the UE. Due to, for example, lower latency associated with a communication performed with a TN entity, the UE may prefer (e.g., be configured with a preference for) connecting to and communicating via a TN. However, an NTN may provide coverage in areas of limited TN coverage.

In some NTNs, a UE may receive paging based on performing TAUs. In some cases, the UE may perform a TAU based on entering a TA not indicated by (e.g., excluded from) a TAI list of an NTN entity. For example, the NTN entity may broadcast pages to UEs within TAs associated with each TAC in the TAI list, and thus the UEs may receive pages based on being in a TA indicated by the TAI list. To determine which TAs are indicated by the TAI list, the UE may register (e.g., establish an IDLE link) with the NTN entity, and the NTN entity may transmit an indication of the TAI list to the UE based on the registration. If the UE detects that the UE has moved into a TA associated with a TAC not included in the TAI list of the NTN entity, the UE may perform a TAU to indicate a location of the UE to a network, allowing the UE to receive paging from the NTN entity, or another network entity (e.g., including NTN entities). In some examples, the registration procedure may include or be based on transmitting a TAU.

In some cases, the UE may move from a first TA to a second TA and may perform a TAU with the NTN entity based on a TAC of the second TA being different than the TAC of the first TA (e.g., and the TAC of the second TA not being in the TAI list of the NTN entity). Additionally, or alternatively, the UE may enter a second cell associated with a second NTN entity and may perform a TAU with the second NTN entity based on entering the second cell (e.g., and registering with the second NTN entity). In some cases, the UE may perform such TAUs while operating in an idle mode (e.g., RRC_IDLE, RRC_INACTIVE, and while moving). In this way, the UE may receive pages (e.g., mobile tracking (MT) pages) via the NTN.

In some cases, a UE may perform more TAUs with NGSO entities than with GSO entities. For example, NGSO entities may cover (e.g., typically) smaller areas (e.g., serve smaller cells) than GSO entities. Thus, a TAI list of an NSGO entity may contain less TACs (e.g., be lesser, correspond to less TACs) than a TAI list of a GSO entity.

In some cases, the wireless communications system 200 may be an NTN network, where the UE 115-a may not have access to a TN (e.g., via network entity 105-a). In some cases, the UE may be located within a GSO cell 205 served by the GSO entity 290 and within one or more NGSO cells 210 (e.g., an NGSO cell 210-a, an NGSO cell 210-b, and an NGSO cell 210-c) served by a respective one of the NGSO entities 285, and thus the UE 115-a may have access to GSO NTN coverage, NGSO NTN coverage, or both. Additionally, the UE 115-a may be an NTN UE, and thus the UE 115-a may be able to camp on the GSO entity 290, an NGSO entity 285, or both. In some cases, the GSO entity 290 may also be an NGSO entity associated with a cell size that is larger than the cell sizes associated with the NGSO entities 285. According to techniques described herein, the UE 115-a may avoid performing frequent TAUs via interworking between the GSO entity 290 and one or more of the NGSO entities 285 to communicate (e.g., decode) pages on the NTN.

According to techniques described herein, the UE 115-a may perform a dual registration with the GSO entity 290 and an NGSO entity 285, such as, for example, the NGSO entity 285-a. While the UE 115-a is dual-registered (e.g., registered with both the GSO entity 290 and the NGSO entity 285-a), the GSO entity 290 may communicate pages (e.g., the UE 115-a may monitor for and decode pages using the GSO network) directly to the UE 115-a. Additionally, the NGSO entity 285-a may maintain a connection (e.g., a wireless link) with the UE 115-a to provide other signaling (e.g., data signaling, messaging), since the NGSO cell 210-a is smaller and associated with less latency than the GSO cell 205. Thus, since the TAI list of the GSO entity 290 is larger than the TAI list of each NGSO entity 285 (e.g., the TAI list of the GSO entity 290 covers a larger geographic area than the TAI list of one or more NGSO entities 285), the UE 115-a may avoid performing some TAUs (e.g., if TAU is for TA change) on NGSO network, which may save (e.g., decrease) TAU signaling from the UE 115-a on an NGSO network.

In a first step, the UE 115-a may identify the GSO entity 290 for establishing a connection (e.g., as part of the dual registration). For example, the UE 115-a may camp on (e.g., establish a connection with, or adjust reception and transmission parameters to) the NGSO entity 285-a. The UE 115-a may perform one or more measurements (e.g., neighbor measurements, while camped on the NGSO entity) associated with a network availability of the GSO entity 290. For example, the UE 115-a may perform the measurements (e.g., search for the GSO cell 205) by receiving and decoding neighbor NTN measurement configuration signaling, which may be broadcasted (e.g., by a TN, an NTN, or both) in a system information block (SIB). Additionally, or alternatively, the UE 115-a may perform the one or more measurements by performing a public land mobile network (PLMN) search. In some cases (e.g., after finding the GSO cell 205 via the one or more measurements), the UE 115-a may store, in a database, a mapping between the GSO cell 205 and the GSO cell 205, creating a mapping between geographic locations and NTN entities. Additionally, or alternatively, the UE 115-a may identify the GSO entity 290 for performing dual registration based on identifying the GSO entity 290 from the mapping stored in the database.

In some cases, the UE 115-a may determine the GSO entity 290 for establishing the connection based on receiving information from the network. For example, the UE 115-a may receive an NTN GSO configuration, a TAI list configuration, or both, to assist in identifying the GSO entity 290 for performing the dual registration with the GSO entity 290, for configuring a secondary receiver to the GSO entity 290, or both, and to receive paging from an NTN with less TAU signaling overhead. In some cases, the UE 115-a may receive an information element (IE) indicating the information, where the IE may be included in a mandatory SIB, a SIB19, or a SIB-XY. For example, the IE may be of the following form:

System InformationBlock-XY

| | | |
|---|---|---|
| { | | |
| . . . | | |
| ntn-gso-Config-r17 | associate_NTN-GSO-Config-r17 | OPTIONAL, -- Need R |
| ntn-GSO-TAIList-rXY | associate_NTN_GSO_tai_list-rXY | OPTIONAL, -- Need R |
| ntn_GSO_PCCH-Config | associate_NTN_GSO-pcch_cfg | OPTIONAL, -- Need R |
| . . . | | |
| }. | | |

In some cases, the UE 115-a may establish a connection (e.g., a wireless link) with the GSO entity 290 based on registering with the GSO entity 290. For example, the UE 115-a may register with the GSO entity 290 based on searching for or identifying the GSO as described herein. The UE 115-a may transmit a TAC to the GSO entity 290, as described herein, which may register the UE 115-a with the GSO entity 290. The UE 115-a may establish a connection (e.g., a wireless link) with the GSO entity 290 (e.g., move to the GSO entity 290) based on registering with the GSO entity 290. In some cases (e.g., if the UE 115-a is not already connected to the NGSO entity 285-a), the UE 115-a may establish the connection with the GSO entity 290 separately, concurrently, or in a same procedure (e.g., via a same or separate transmission) as establishing a connection with the NGSO entity 285-a. The UE 115-a may begin receiving physical control channel (e.g., PCCH) information from the GSO entity 290 and the NGSO entity 285-a.

In some cases, the UE 115-a may monitor for paging signaling from the GSO entity 290, for example, without performing TAUs with the NGSO entity 285-a. In some cases, the UE 115-a may switch a receiver, such as a secondary receiver (e.g., receiving chain) to monitor the GSO entity 290 (e.g., to the GSO PCCH information). For example, the UE 115-a may monitor, via, for example, the secondary receiver, one or more POs 270 associated with the GSO entity 290.

In some cases, the NGSO entity 285-a (e.g., involved in the dual registration of the UE 115-a) may assist in transmitting pages to the UE 115-a. For example, the NGSO entity 285-a may transmit one or more pages (e.g., including MT pages) intended for the UE 115-a to the GSO entity 290 based on the UE performing the dual registration with the NGSO entity 285-a and the GSO entity 290. As long as the one or more pages are for the UE 115-a in a TAC supported by the TAI list (e.g., included in the TAI list) of the GSO entity, the GSO may transmit (e.g., broadcast) the one or more pages to the UE 115-a. In some cases, the GSO may transmit the one or more pages, and the UE 115-a may monitor for the one or more pages, during the POs 270.

As discussed herein, the UE 115-a may receive paging from the GSO entity 290 via one or more POs 270. In some cases, the NGSO entity 285-a may be associated with POs 270 different from POs associated with the GSO entity 290. For example, PO diagram 255 may include POs 270 associated with the NGSO entity 285, with an exemplary spacing of three slots in between each PO 270. The GSO entity 290 may be associated with one or more of the PO diagram 260 and the PO diagram 265. For example, the GSO entity may be associated with the POs of the PO diagram 260, where the POs 270 associated with the GSO entity 290 are the same as the POs associated with the NGSO entity 285-a. Additionally, or alternatively, the GSO entity 290 may be associated with the POs 270 of the PO diagram 265, where the POs 270 associated with the GSO entity 290 are different from the POs 270 associated with the NGSO entity 285-a.

For example, in a first case where the GSO entity 290 is associated with POs 270 that may be the same as POs 270 associated with the NGSO entity 285-a (e.g., PO diagram 260), the UE 115-a may monitor for paging via a primary receiver of the UE 115-a, via a secondary receiver of the UE 115-a, or both. In a second case where the GSO entity 290 is associated with POs 270 that may be different from POs 270 associated with the NGSO entity 285-a (e.g., PO diagram 265), an NTN entity, a TN entity, or another network entity may configure the POs 270 associated with the GSO entity 2980 (e.g., and associated with the secondary receiver of the UE 115-a). In either of the first case or the second case, the UE 115-a may select the primary receiver, the secondary receiver, or both, for receiving and decoding pages.

In some cases, the UE 115-a may communicate different information with the GSO entity 290 and one or more NGSO entities 285. In some examples, the UE 115-a may prioritize connected mode communications (e.g., via the GSO entity 290 or one of the NGSO entities 285), based on one or more factors. For example, since the GSO entity 290 may be orbiting further from earth than the NGSO entities 285, the UE 115-a may use more UL power to send signaling (e.g., a payload) to the GSO entity 290, and there may be a longer delay associated with signaling between the UE 115-a and the GSO entity 290 than between the UE 115-a and the NGSO entities 285. Thus, in some cases, the UE 115-a may receive paging from the GSO entity 290, and may determine whether to communicate (e.g., transmit or receive) other signaling with the GSO entity 290 or the NGSO entity 285-a based on one or more factors. For example, the one or more factors may include a service type (e.g., call type) associated with (e.g., requested by, corresponding to subsequent communications of, used by) the UE 115-a, where the UE 115-a may communicate signaling with the GSO entity 290 if the GSO entity 290 supports a service type associated with the UE 115-a. As another example, the one or more factors may include quality of service (QoS) associated with the GSO entity 290, where the UE 115-a may communicate other signaling with the GSO entity 290 if a measure QoS of the GSO entity 290 satisfies (e.g., is above) a QoS threshold. As yet another example, the one or more factors may include a wireless communication throughput associated with the UE 115-a, where the UE 115-a may communicate other signaling with the NGSO entity 285-a if the wireless communication throughput associated with the UE 115-a satisfies (e.g., is higher than) a threshold throughput. In some cases, the one or more factors (e.g., and corresponding thresholds or values) may be defined in one or more standards documents.

Additionally, or alternatively, the UE 115-a may receive control signaling configuring one or more parameters associated with NTN entity communication. In some examples, the UE 115-a may determine whether to perform wireless communications (e.g., in connected mode) via the GSO entity 290 or an NGSO entity 285 based on the one or more parameters. For example, the UE 115-a may receive control signaling configuring a preference to establish a wireless link (e.g., and communicate one or more types of signaling) with either a GSO-type NTN entity or an NGSO-type NTN entity. In some examples, the UE 115-a may receive control signaling indicating a service type (e.g., call type) configuration, such that each service type associated with the UE 115-a may correspond to (e.g., be communicated with) either a GSO-type NTN entity or an NGSO-type NTN entity. As yet another example, the UE 115-a may receive control signaling configuring a throughput threshold, where the UE 115-a may establish a connection with (e.g., and communicate one or more types of signaling with) an NGSO-type NTN entity if a throughput is greater than the throughput threshold. In some cases, the one or more parameters may be specific to the UE 115-a, to a group of UEs including the UE 115-a with a common preference, to a group of UEs including the UE 115-a with a common original equipment manufacturer (OEM), or any combination thereof.

In some cases, the GSO entity 290 may assist in scenarios of low NGSO service availability (e.g., and TN service availability) to a UE 115. For example, a UE 115-b may be within the GSO cell 205, but outside of the NGSO cells 210 and a TN cell 215 served by the network entity 105-a. In such a scenario, the UE 115-b may detect a discontinuity in NGSO coverage (e.g., and TN coverage), and may switch a primary receiver of the UE 115-b to monitoring and receiving from the GSO entity 290. Stated differently, the UE 115-b may prioritize establishing a connection with the GSO entity 290 (e.g., or camping on the GSO entity 290) over other connections if the UE 115-b detects no available TN service and detects a discontinuity in the (e.g., a lack of) coverage provided by the NGSO entities 285.

In some cases, a UE 115 (e.g., the UE 115-a, the UE 115-b) may receive prediction information indicating NTN entities (e.g., NSGO entities) that will be available to for providing service to the UE 115 based on orbiting locations of the NTN entities. For example, the UE 115 may receive a SIB (e.g., a SIB32) indicating the prediction information. In some cases, the UE 115 may use the prediction information to identify upcoming NTN entities to measure for service availability and to establish a connection with. The UE 115 may perform the measurement of an NTN entity of the upcoming NTN entities beginning at a time when the NTN entity begins providing service to the UE 115 (e.g., t_in_service of an incoming satellite), where the time may be indicated by the prediction information.

In some cases, the GSO entity 290 may handover the UE 115-a to the NGSO entity 285-a for improved communications. For example, the GSO entity 290 may handover the UE 115-a to the NGSO entity 285-a based one a dual connectivity between GSO entity 290 and the NGSO entity 285-a, receiving information associated with the NGSO entity 285-a (e.g., and other NGSO entities 285 in a same TA), detecting the availability of improved throughput for the UE 115-a from the NGSO entity 285-a, or any combination thereof.

In some cases, the GSO entity 290 may determine one or more handover criteria for performing the handover of the UE 115-a from the GSO entity 290 to the NGSO entity 285-a. For example, the one or more handover criteria may include a service type (e.g., call type) requested by the UE 115-a, where the GSO entity 290 may handover the UE 115-a to the NGSO entity if the UE 115-a requests a certain service type. As another example, the one or more criteria may include a QoS criteria, where the GSO entity 290 may handover the UE 115-a to the NGSO entity 285-a based on a QoS associated with the GSO entity 290 satisfying (e.g., being lower than) a threshold, based on a QoS associated with the NGSO entity 285-a satisfying (e.g., being higher than) a threshold, or both. As yet another example, one or more criteria may include a wireless communication throughput criterion, where the GSO entity 290 may handover the UE 115-a to the NGSO entity 285-a if a wireless communication throughput requested by the UE 115-a satisfies (e.g., is higher than) a throughput threshold. As yet another example, the one or more criteria may include a reference signal receive power (RSRP) threshold, where the GSO entity 290 may handover the UE 115-a to the NGSO entity 285-a if an RSRP associated with the NGSO entity 285 satisfies (e.g., is higher than) an RSRP threshold. In some cases, the GSO entity 290 may receive control signaling configuring the RSRP threshold. Additionally, or alternatively, after a connection release for the UE 115-a from the NGSO entity 285-a, the NGSO entity 285-a may configure the UE 115-a with a one or more criteria (e.g., a dedicated configuration) to re-establish a connection with (e.g., perform redirection/reselection to move back on) the GSO entity 290.

In some cases, one or more of the NTN entities (e.g., the NGSO entities 285) may be associated with high mobility. For example, the NGSO entities 285 may include low Earth orbit (LEO) satellites, medium earth orbit (MEO) satellites, or both, where the LEO satellites may be associated with a higher mobility (e.g., larger velocity) than the MEO satellites, and the LEO and MEO satellites may both be associated with higher mobilities than the GSO entity 290. In a case where the UE 115-a may be dual-registered to an NGSO entity 285 and the GSO entity 290, and when the NGSO entities 285 may have a high mobility, the UE 115-a may perform frequent TAUs to register with changing NGSO entities 285.

According to aspects of the present disclosure, and to prevent the UE 115-a performing frequent TAUs (e.g., due to NGSO entities 285 entities with high mobility, due to a high mobility of the UE 115-a causing the UE 115-a to pass through many TAs), the UE 115-a may enter a deep sleep mode (e.g., idle mode, RRC_IDLE, RRC_INACTIVE) while dual-registered with the GSO entity 290 and an NGSO entity 285. For example, after dual registering with the GSO entity 290 and the NGSO entity 285, the UE 115-a may detect a high mobility of the UE 115-a, the NGSO entity 285-a, or both, and may enter the deep sleep mode to save power and avoid performing frequent TAUs. For example, the UE 115-a may determine that a mobility of the UE 115-a satisfies (e.g., is larger than) a mobility threshold, that a mobility associated with the NGSO entity 285-a satisfies (e.g., is larger than) a mobility threshold, or both.

In some cases, the UE 115-a may enter the deep sleep mode for a sleep duration. During the sleep duration, the UE 115-a may monitor POs 270 associated with the GSO entity 290 to receive (e.g., decode) paging, and the UE 115-a may not perform TAUs (e.g., even after entering a different cell or TA) to save power and reduce communication resource usage. After the sleep duration expires, the UE 115-a may perform a cell select on an NGSO entity 285. Additionally, or alternatively, if a TA associated with the UE 115-a changed during the sleep duration, the UE 115-a may detect a TA change, and may perform (e.g., trigger) a TAU with the NGSO entity 285. In this way, establishing a connection (e.g., wireless link) with the NGSO entity 285 after the sleep duration may be performed with less latency due to the UE 115-a being registered with (e.g., having a TAC in the TAI list of the) NGSO entity 285.

In some cases, the UE 115-a may wake up from the deep sleep mode before the expiration of the sleep duration. For example, the UE 115-a may receive one or more pages (e.g., MT pages) during the sleep duration, and may wake up based on receiving the MT pages. If the UE 115-a wakes up during the sleep duration, the UE 115-a may perform one or more measurements, searching for the NGSO entity 285 that the UE 115-a was registered with before entering the deep sleep mode. The UE 115-a may establish a connection with the NGSO entity 285 based on the measurements and one or more factors, such as the factors described herein. In some other cases, the UE 115-a may wake up during the sleep duration and establish a connection with the GSO entity 290.

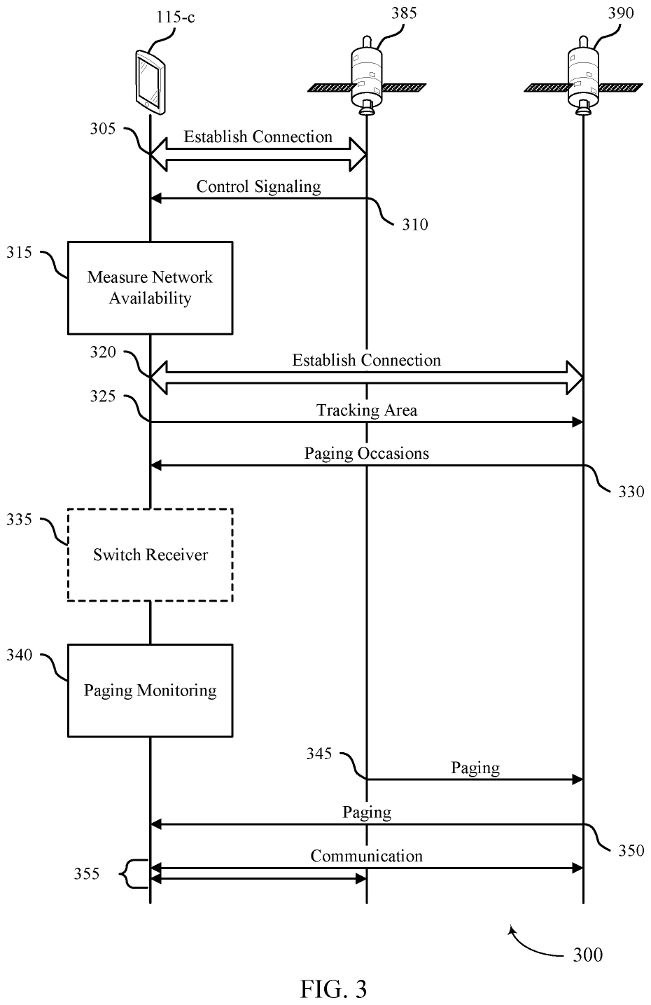

FIG. 3 shows an example of a process flow 300 that supports techniques for paging in an NTN in accordance with one or more aspects of the present disclosure. In some cases, aspects of the process flow 300 may implement or be implemented by aspects of FIGS. 1-2. For example, the process flow 300 may include a UE 115-c and NTN entities (e.g., an NGSO entity 385, a GSO entity 390), which may be examples of a UE 115 and NTN entities as described herein with respect to FIGS. 1 and 2. In some cases, the UE 115-c may perform a dual registration with the NGSO entity 385 and the GSO entity 390 and may receive paging from the GSO entity 390 based on the dual registration.

In the following description of process flow 300, the operations may be performed in a different order than the order shown, or other operations may be added or removed from the process flow 300. For example, some operations may also be left out of process flow 300, may be performed in different orders or at different times, or other operations may be added to process flow 300. Although the UE 115-c and the NTN entities (e.g., the GSO entity 390 and the NGSO entity 385) are shown performing the operations of process flow 300, some aspects of some operations may also be performed by one or more other wireless devices or network devices. Additionally, or alternatively, the GSO entity 390 may be replaced with an NGSO entity serving a cell that covers at least part of a cell served by the NGSO entity 385.

At 305, the UE 115-c may establish a first communication link (e.g., wireless link, connection link, or registration) with the NGSO entity 385 (e.g., a first an NTN entity). In some cases, at least a first receiver (e.g., primary receiver, receive chain) of a set of receivers of the UE 115-c may correspond to the first communication link. Additionally, or alternatively, the UE 115-c may establish the connection based on a TA associated with the UE 115-c corresponding to the NGSO entity 385. In some cases, the GSO entity 385 may transmit data signaling to the UE 115-c via the communication link based on the TA.

At 310, the UE 115-c may receive control signaling (e.g., from the NGSO entity 385) indicating information associated with the GSO entity 390 (e.g., a second an NTN entity). For example, the information may include a satellite type of the GSO entity 390, one or more resources for communications with the GSO entity 390, or one or more locations associated with the GSO entity 390, or any combination thereof. In some cases, the control signaling may be a SIB (e.g., as described herein with respect to FIG. 2).

In some cases, the control signaling may indicate one or more parameters associated with communication between the UE 115-c and the NTN entities. For example, the one or more parameters may include an indication that the NGSO entity 285 or the GSO entity 290 is a default (e.g., preferred) NTN device (e.g., NTN entity), a service type associated with the NGSO entity 285 (e.g., one or more service types that the NGSO entity 285 may support), a service type associated with the GSO entity 290, a service type associated with the NGSO entity 285 and the GSO entity 290, or a throughput threshold (e.g., as described herein with respect to FIG. 2), or any combination thereof.

At 315, the UE 115-c may perform one or more measurements associated with a network availability of the GSO entity 290. For example, the one or more measurements mat include a public land mobile network search or decoding one or more NTN measurement configurations broadcasted by the GSO entity 290, or both (e.g., as described herein with respect to FIG. 2).

In some cases, the UE 115-c may identify, based on the one or more measurements, the GSO entity 290, a location associated with the GSO entity 290, or both. The UE 115-c may store, in a database, a mapping between one or more locations and the NGSO entity 285, the GSO entity 290, or both, based on, in some examples, the one or more measurement. In some cases, the UE 115-c may skip performing the measurements and may identify the GSO entity 290 for performing a dual registration based on the stored mapping (e.g., as described herein with respect to FIG. 2).

At 320, the UE 115-c may establish a second communication link with the GSO entity 390 based on (e.g., as part of) registering with the GSO entity 390. In some cases, the UE 115-c may establish the second communication link before, simultaneously, or after establishing the first communication link. Additionally, or alternatively, the second communication link may be established separately from the first communication link, or in a same action (e.g., via a same signaling). For example, the UE 115-c may register with the GSO entity 390 as part of a dual registration of the UE 115-c with the NGSO entity 385 and the GSO entity 390. The UE 115-c may also receive a TAI list of the GSO entity 390 (e.g., as described herein with respect to FIGS. 1 and 2) based on registering with the GSO entity 290.

In some cases, the UE 115-c may register with the GSO entity 390 based on the receiving the control signaling at 310 indicating the information associated with the GSO entity 390. For example, the UE 115-c may identify the GSO entity 390 for registering (e.g., for dual registration) based on the information about the GSO entity 390. Additionally, or alternatively, registering with the GSO entity 390 may be based on the stored mapping, where the UE 115-c may reference the stored mapping to identify the GSO entity 390 for dual registration. Additionally, or alternatively, the registering with the GSO entity 390 may be based on the one or more measurements associated with the network availability of the GSO entity 390.

At 325, the UE 115-c may transmit, to the GSO entity 290, control signaling indicating the TA associated with the UE 115-c. In some cases, transmitting the control signaling to the GSO entity 290 may be based on the UE 115-c registering with the GSO entity 290, where registering with the GSO entity 290 may include establishing the communication link with the GSO entity 290 at 320. For example, the UE 115-c may transmit the control information indicating the TA if the TA is associated with a TAC not included in the TAI list of the GSO entity 290.

At 330, the UE 115-c may receive, via the second communication link, control signaling indicating a set of POs for paging signaling from the GSO entity 390. In some cases, the set of POs may at least partially overlap with one or more POs corresponding to the first communication link with the NGSO entity 385. In some cases, the set of POs may be different than the one or more POs corresponding to the first communication link with the NGSO entity 385.

At 335, the UE 115-c may switch a second receiver (e.g., a secondary receiver, a receive chain) from the first communication link to the second communication link (e.g., as described herein with respect to FIG. 2). For example, the UE 115-c may (e.g., initially) receive one or more types of signaling from the NGSO entity 385 via the second receiver. The UE 115-c may, based on establishing the connection with the GSO entity 390 and receiving the indication of the one or more POs, switch the second receiver to being used to monitor the second communication link for (e.g., at least) pages. The second receiver may be of the set of receivers of the UE 115-c.

At 340, the UE 115-c may monitor the second communication link for paging signaling from the GSO entity 390 via the second receiver of the set of receivers of the UE 115-c. In some cases, the UE 115-c may monitor the second communication link for the paging signaling based on switching the second receiver to the second communication link. Additionally, or alternatively, the UE 115-c may monitor the second communication link based on the control signaling indicating the set of paging occasions at 330.

Additionally, or alternatively, the UE 115-c may switch the first receiver from the first communication link to the second communication link, for example, to monitor for the paging from the GSO entity 390. In some cases, the UE 115-c may switch the first receiver to the second communication link based on determining a discontinuous coverage associated with at least the NGSO entity 385 (e.g., as discussed herein with respect to FIG. 2). For example, the UE 115-c may monitor the second communication link for the paging signaling via the first receiver, or the second receiver, or both.

In some cases, the NGSO entity 385 may transmit paging signaling to the UE 115-c via the GSO entity 390. For example, at 345, the NGSO entity 385 may transmit the paging signaling to the GSO entity 390 for forwarding to the UE 115-c via the second communication link between the UE and the GSO entity 390. In some cases, the NGSO entity 385 may transmit the paging signaling to the GSO entity 390 based on the GSO entity 390 serving a cell corresponding to a set of TAs, where the set of TAs includes the TA associated with the UE 115-c (e.g., as described herein with respect to FIG. 2).

At 350, the UE 115-c may receive the paging signaling from the GSO entity 390 based on monitoring the second communication link for the paging signaling. In some cases, the GSO entity 390 may transmit the paging signaling to the UE 115-c via the second communication link in at least one PO of the set of POs (e.g., received at 330). The GSO entity 390 may autonomously transmit the paging signaling to the UE 115-c. Or, in some examples, the GSO entity 390 may receive the paging signaling from the NGSO entity 385 at 345 and may forward the paging signaling to the UE 115-c at 350.

At 355, the UE 115-c may transmit uplink signaling to the NGSO entity 385 or the GSO entity 390 based on one or more actions or conditions. For example, the one or more actions or conditions may include receiving the paging signaling (e.g., from the GSO entity 390), a service type associated with the UE 115-c (e.g., requested by the UE 115-c), a QoS measurement associated with the GSO entity 390, or a wireless communication throughput associated with the UE 115-c, or any combination thereof. Additionally, or alternatively, the UE 115-c may transmit uplink signaling to the NGSO entity 385 or the GSO entity 390 based on the one or more parameters received at 310.

Additionally, or alternatively, the UE 115-c may receive control signaling (e.g., downlink control signaling, DCI, MAC CE, RRC) from the GSO entity 390, where the control signaling may trigger a handover for the UE 115-c from the GSO entity 390 to the NGSO entity 385. In some cases, the GSO entity 390 may transmit the control signaling to trigger the handover based on a service type associated with the UE 115-c, a QoS measurement associated with the GSO entity 390, a wireless communication throughput associated with the UE 115-c, or an RSRP associated with the NGSO entity 385, or any combination thereof (e.g., as described herein with respect to FIG. 2). For example, the UE 115-c may switch the second receiver from the second communication link to the first communication link based on receiving the control signaling triggering the handover.

Additionally, or alternatively, the UE 115-c may operate in a deep sleep mode for a time duration (e.g., a sleep duration) based on registering with the GSO entity 390, a first mobility (e.g., velocity) associated with the UE 115-c satisfying a first mobility threshold, or a second mobility associated with the NGSO entity 385 satisfying a second mobility threshold, or any combination thereof. Additionally, or alternatively, the UE 115-c may transmit, after the time duration, an indication of a TA associated with the UE 115-c based on a change in the TA (e.g., as described herein with respect to FIG. 2).

In some cases, the UE 115-c may also receive various signaling via the first receiver of the UE 115-c, the second receiver of UE 115-c, or both. For example, the UE 115-c may receive data signaling, control signaling, or both, via the first receiver based on the first receiver being a primary receiver of the UE 115-c. The UE may also receive the paging signaling via the second receiver based on the second receiver being a secondary receiver of the UE 115-c.

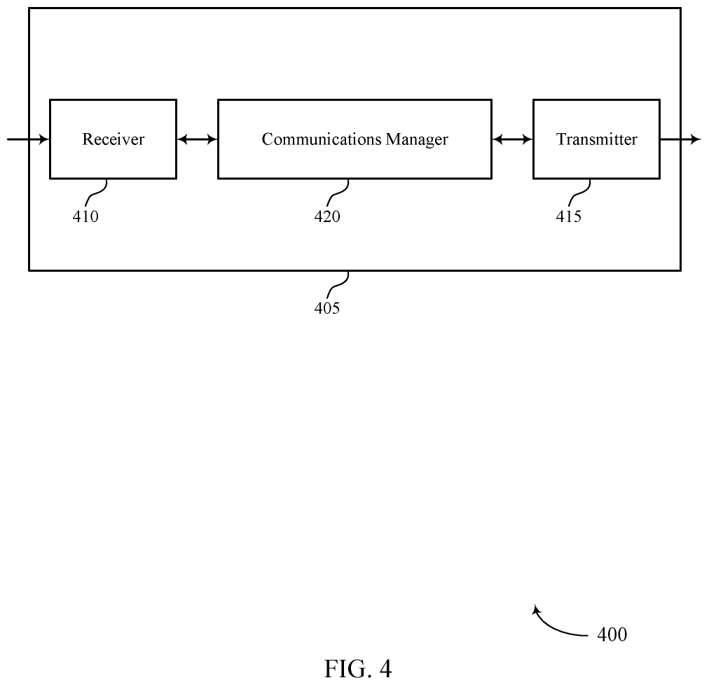

FIG. 4 shows a block diagram 400 of a device 405 that supports techniques for paging in an NTN in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for paging in an NTN). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for paging in an NTN). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for paging in an NTN as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for establishing a first communication link with a first an NTN entity, at least a first receiver of a set of receivers of the UE corresponding to the first communication link. The communications manager 420 is capable of, configured to, or operable to support a means for establishing a second communication link with a second an NTN entity based on registering with the second an NTN entity, the registering being based on one or more measurements associated with a network availability of the second an NTN entity. The communications manager 420 is capable of, configured to, or operable to support a means for monitoring the second communication link for paging signaling from the second an NTN entity via a second receiver of the set of receivers of the UE. The communications manager 420 is capable of, configured to, or operable to support a means for receiving the paging signaling from the second an NTN entity based on monitoring the second communication link for the paging signaling.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources. For example, a UE implementing techniques described herein may perform less TAUs while changing locations, which may conserve power at the UE and utilize less communication resources. Additionally, the UE may enter a low power mode and remain in the low power mode for longer, based on waking up less often to perform TAUs, which may reduce power consumption at the UE.

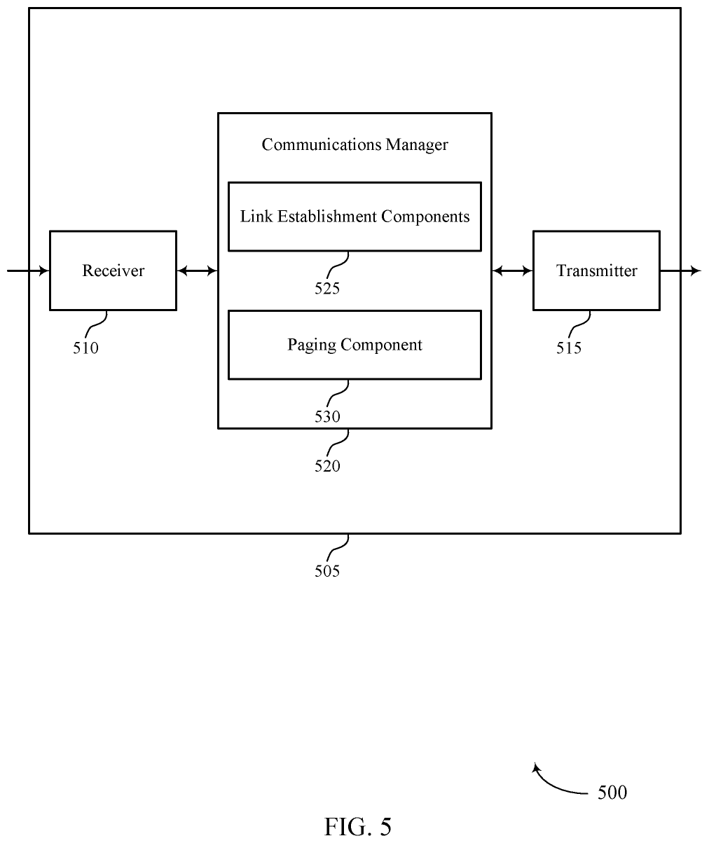

FIG. 5 shows a block diagram 500 of a device 505 that supports techniques for paging in an NTN in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for paging in an NTN). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for paging in an NTN). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for paging in an NTN as described herein. For example, the communications manager 520 may include a link establishment components 525 a paging component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The link establishment components 525 is capable of, configured to, or operable to support a means for establishing a first communication link with a first an NTN entity, at least a first receiver of a set of receivers of the UE corresponding to the first communication link. The link establishment components 525 is capable of, configured to, or operable to support a means for establishing a second communication link with a second an NTN entity based on registering with the second an NTN entity, the registering being based on one or more measurements associated with a network availability of the second an NTN entity. The paging component 530 is capable of, configured to, or operable to support a means for monitoring the second communication link for paging signaling from the second an NTN entity via a second receiver of the set of receivers of the UE. The paging component 530 is capable of, configured to, or operable to support a means for receiving the paging signaling from the second an NTN entity based on monitoring the second communication link for the paging signaling.

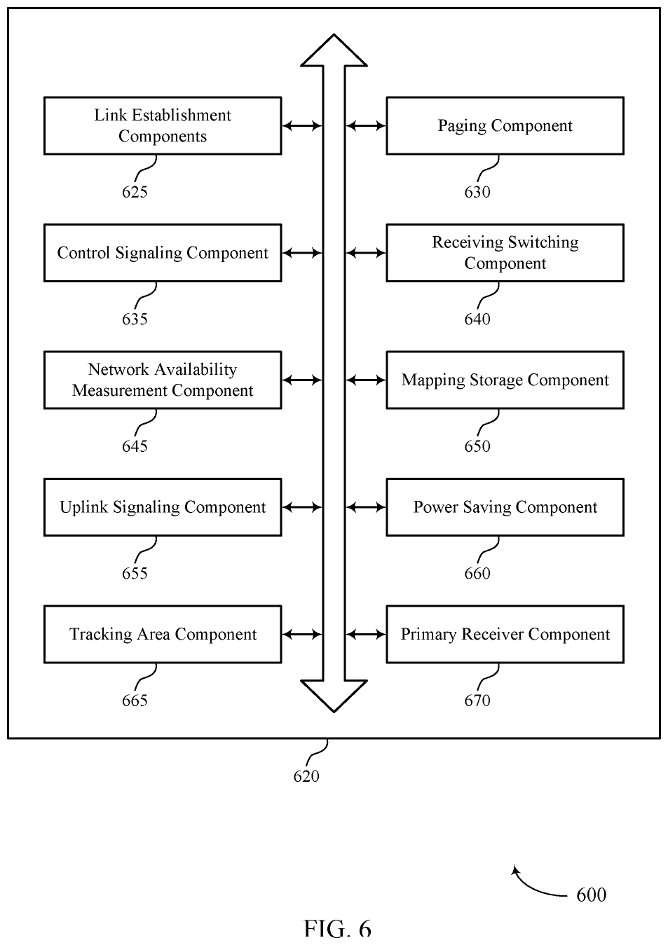

FIG. 6 shows a block diagram 600 of a communications manager 620 that supports techniques for paging in an NTN in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for paging in an NTN as described herein. For example, the communications manager 620 may include a link establishment components 625, a paging component 630, a control signaling component 635, a receiver switching component 640, a network availability measurement component 645, a mapping storage component 650, an uplink signaling component 655, a power saving component 660, a TA component 665, a primary receiver component 670, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The link establishment components 625 is capable of, configured to, or operable to support a means for establishing a first communication link with a first an NTN entity, at least a first receiver of a set of receivers of the UE corresponding to the first communication link. In some examples, the link establishment components 625 is capable of, configured to, or operable to support a means for establishing a second communication link with a second an NTN entity based on registering with the second an NTN entity, the registering being based on one or more measurements associated with a network availability of the second an NTN entity. The paging component 630 is capable of, configured to, or operable to support a means for monitoring the second communication link for paging signaling from the second an NTN entity via a second receiver of the set of receivers of the UE. In some examples, the paging component 630 is capable of, configured to, or operable to support a means for receiving the paging signaling from the second an NTN entity based on monitoring the second communication link for the paging signaling.

In some examples, the control signaling component 635 is capable of, configured to, or operable to support a means for receiving, via the second communication link, control signaling indicating a set of paging occasions for the paging signaling from the second an NTN entity, where the set of paging occasions at least partially overlaps with one or more paging occasions corresponding to the first communication link with the first an NTN entity, and where the monitoring is based on the control signaling indicating the set of paging occasions.

In some examples, the control signaling component 635 is capable of, configured to, or operable to support a means for receiving, via the second communication link, control signaling indicating a set of paging occasions for the paging signaling from the second an NTN entity, where the set of paging occasions is different than one or more paging occasions corresponding to the first communication link with the first an NTN entity, and where the monitoring is based on the control signaling indicating the set of paging occasions.

In some examples, the receiver switching component 640 is capable of, configured to, or operable to support a means for switching the second receiver from the first communication link to the second communication link, where monitoring the second communication link for the paging signaling is based on the switching.

In some examples, the control signaling component 635 is capable of, configured to, or operable to support a means for receiving control signaling indicating information associated with the second an NTN entity including a satellite type of the second an NTN entity, one or more resources for communications with the second an NTN entity, or one or more locations associated with the second an NTN entity, or any combination thereof, where registering with the second an NTN entity is based on the control signaling indicating the information associated with the second an NTN entity.

In some examples, to support receiving the control signaling indicating the information associated with the second an NTN entity, the control signaling component 635 is capable of, configured to, or operable to support a means for receiving a system information block.

In some examples, the network availability measurement component 645 is capable of, configured to, or operable to support a means for performing the one or more measurements associated with the network availability of the second an NTN entity, where the one or more measurements include a public land mobile network search, or decoding one or more an NTN measurement configurations broadcasted by the second an NTN entity, or both.

In some examples, the mapping storage component 650 is capable of, configured to, or operable to support a means for storing, in a database, a mapping between one or more locations and the first an NTN entity, the second an NTN entity, or both, where registering with the second an NTN entity is based on the mapping.

In some examples, the uplink signaling component 655 is capable of, configured to, or operable to support a means for transmitting uplink signaling to the first an NTN entity or the second an NTN entity based on receiving the paging signaling, a service type associated with the UE, a quality of service measurement associated with the second an NTN entity, or a wireless communication throughput associated with the UE, or any combination thereof.

In some examples, the control signaling component 635 is capable of, configured to, or operable to support a means for receiving control signaling indicating one or more parameters including an indication that the first an NTN entity or the second an NTN entity is a default an NTN device, a service type associated with the first NTN entity, a service type associated with the second NTN entity, a service type associated with the first NTN entity and the second NTN entity, or a throughput threshold, or any combination thereof. In some examples, the uplink signaling component 655 is capable of, configured to, or operable to support a means for transmitting uplink signaling to the first NTN entity or the second NTN entity based on receiving the paging signaling and the one or more parameters.

In some examples, the control signaling component 635 is capable of, configured to, or operable to support a means for receiving control signaling from the second NTN entity triggering a handover for the UE from the second NTN entity to the first NTN entity based on a service type associated with the UE, a quality of service measurement associated with the second NTN entity, a wireless communication throughput associated with the UE, or a RSRP associated with the first NTN entity, or any combination thereof. In some examples, the receiver switching component 640 is capable of, configured to, or operable to support a means for switching the second receiver from the second communication link to the first communication link based on receiving the control signaling.

In some examples, the receiver switching component 640 is capable of, configured to, or operable to support a means for switching the first receiver from the first communication link to the second communication link based on determining a discontinuous coverage associated with at least the first NTN entity. In some examples, the paging component 630 is capable of, configured to, or operable to support a means for monitoring the second communication link for the paging signaling via the first receiver, or the second receiver, or both.

In some examples, the power saving component 660 is capable of, configured to, or operable to support a means for operating in a deep sleep mode for a time duration based on registering with the second NTN entity, a first mobility associated with the UE satisfying a first mobility threshold, or a second mobility associated with the first NTN entity satisfying a second mobility threshold, or any combination thereof. In some examples, the TA component 665 is capable of, configured to, or operable to support a means for transmitting, after the time duration, an indication of a TA associated with the UE based on a change in the TA.

In some examples, to support registering with the second NTN entity, the control signaling component 635 is capable of, configured to, or operable to support a means for transmitting control signaling indicating a TA associated with the UE.

In some examples, the first NTN entity includes a non-geostationary orbit satellite. In some examples, the second NTN entity includes a geostationary orbit satellite.

In some examples, the primary receiver component 670 is capable of, configured to, or operable to support a means for receiving data signaling, control signaling, or both, via the first receiver based on the first receiver including a primary receiver of the UE, where the UE receives the paging signaling via the second receiver based on the second receiver including a secondary receiver of the UE.

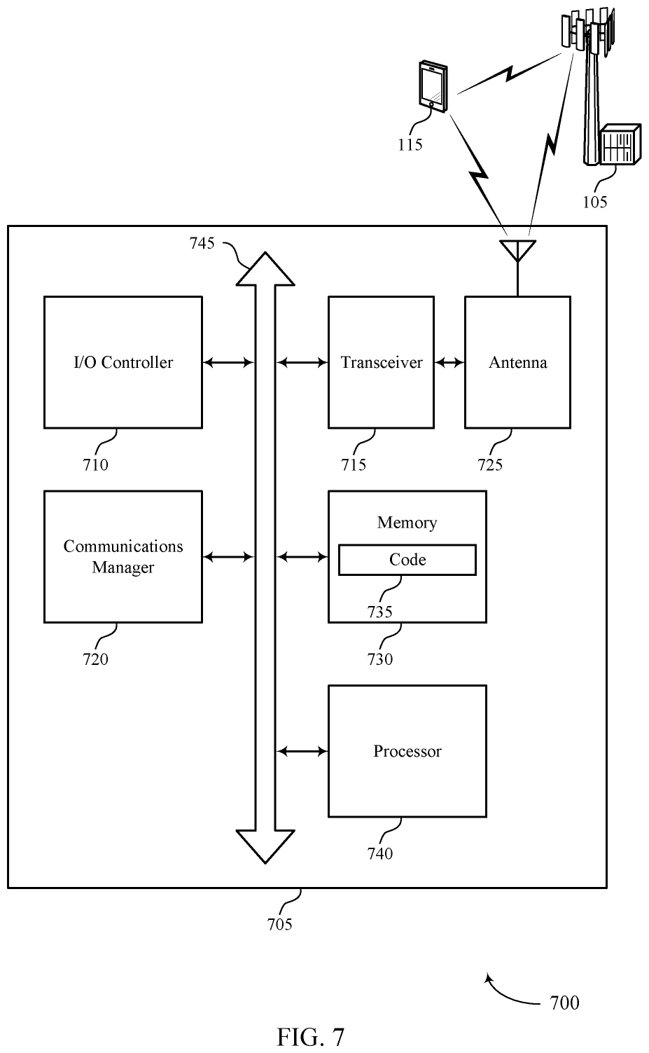

FIG. 7 shows a diagram of a system 700 including a device 705 that supports techniques for paging in an NTN in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for paging in an NTN). For example, the device 705 or a component of the device 705 may include at least one processor 740 and at least one memory 730 coupled with or to the at least one processor 740, the at least one processor 740 and at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. As such, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for establishing a first communication link with a first NTN entity, at least a first receiver of a set of receivers of the UE corresponding to the first communication link. The communications manager 720 is capable of, configured to, or operable to support a means for establishing a second communication link with a second NTN entity based on registering with the second NTN entity, the registering being based on one or more measurements associated with a network availability of the second NTN entity. The communications manager 720 is capable of, configured to, or operable to support a means for monitoring the second communication link for paging signaling from the second NTN entity via a second receiver of the set of receivers of the UE. The communications manager 720 is capable of, configured to, or operable to support a means for receiving the paging signaling from the second NTN entity based on monitoring the second communication link for the paging signaling.

By including or configuring the communications manager 720 in accordance with examples as described herein, the device 705 may support techniques for longer battery life and more efficient utilization of communication resources. For example, a UE implementing techniques described herein may perform less TAUs while changing locations, which may lengthen battery life of the UE and utilize less communication resources. Additionally, the UE may enter a low power mode and remain in the low power mode for longer, based on waking up less often to perform TAUs, which may lengthen the battery life of the UE.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for paging in an NTN as described herein, or the at least one processor 740 and the at least one memory 730 may be otherwise configured to, individually or collectively, perform or support such operations.

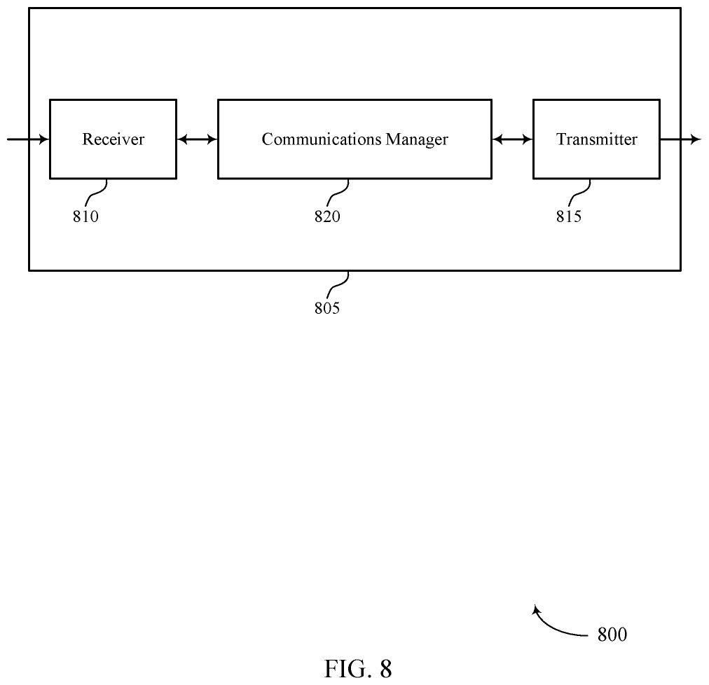

FIG. 8 shows a block diagram 800 of a device 805 that supports techniques for paging in an NTN in accordance with one or more aspects of the present disclosure. The device 805 may be an example of aspects of an NTN entity as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of techniques for paging in an NTN as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for establishing a communication link with a UE associated with a TA corresponding to a first cell served by the first NTN entity. The communications manager 820 is capable of, configured to, or operable to support a means for transmitting data signaling to the UE via the communication link based on the TA. The communications manager 820 is capable of, configured to, or operable to support a means for transmitting paging signaling to the UE via a second NTN entity that serves a second cell corresponding to a set of TAs based on the set of TAs including the TA.

Additionally, or alternatively, the communications manager 820 may support wireless communication in accordance with examples as disclosed herein. For example, the communications manager 820 is capable of, configured to, or operable to support a means for establishing a communication link with a UE based on a registration of the UE with the second NTN entity, the UE being associated with a TA. The communications manager 820 is capable of, configured to, or operable to support a means for receiving paging signaling from a first NTN entity based on the registration and the first NTN entity serving a first cell corresponding to the TA. The communications manager 820 is capable of, configured to, or operable to support a means for transmitting the paging signaling to the UE via the communication link based on the second NTN entity serving a second cell corresponding to a set of TAs including the TA.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources. For example, an NTN entity (e.g., NGSO entity) implementing techniques described herein may perform less TAUs with UEs implementing the techniques described herein, which may conserve power at the NTN entity and utilize less communication resources. Additionally, an NTN entity (e.g., a GSO entity) implementing the techniques described herein may provide for another NTN entity (e.g., an NGSO entity) to perform less TAUs, utilizing less communication resources.

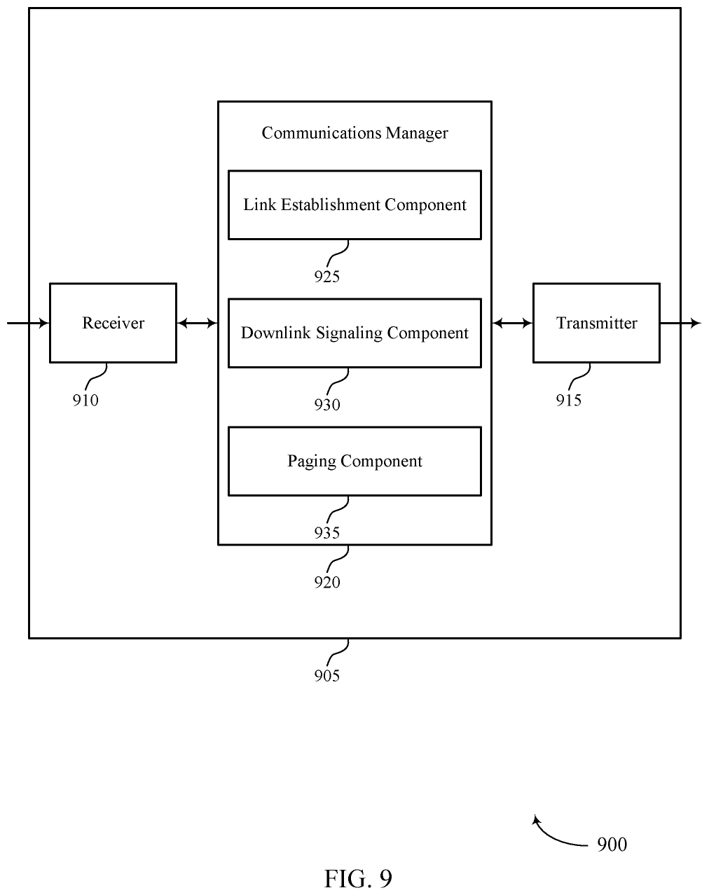

FIG. 9 shows a block diagram 900 of a device 905 that supports techniques for paging in an NTN in accordance with one or more aspects of the present disclosure. The device 905 may be an example of aspects of a device 805 or an NTN entity (e.g., the NTN entity 185, GSO entities, NGSO entities) as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for paging in an NTN as described herein. For example, the communications manager 920 may include a link establishment component 925, a downlink signaling component 930, a paging component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The link establishment component 925 is capable of, configured to, or operable to support a means for establishing a communication link with a UE associated with a TA corresponding to a first cell served by the first NTN entity. The downlink signaling component 930 is capable of, configured to, or operable to support a means for transmitting data signaling to the UE via the communication link based on the TA. The paging component 935 is capable of, configured to, or operable to support a means for transmitting paging signaling to the UE via a second NTN entity that serves a second cell corresponding to a set of TAs based on the set of TAs including the TA.

Additionally, or alternatively, the communications manager 920 may support wireless communication in accordance with examples as disclosed herein. The link establishment component 925 is capable of, configured to, or operable to support a means for establishing a communication link with a UE based on a registration of the UE with the second NTN entity, the UE being associated with a TA. The paging component 935 is capable of, configured to, or operable to support a means for receiving paging signaling from a first NTN entity based on the registration and the first NTN entity serving a first cell corresponding to the TA. The paging component 935 is capable of, configured to, or operable to support a means for transmitting the paging signaling to the UE via the communication link based on the second NTN entity serving a second cell corresponding to a set of TAs including the TA.

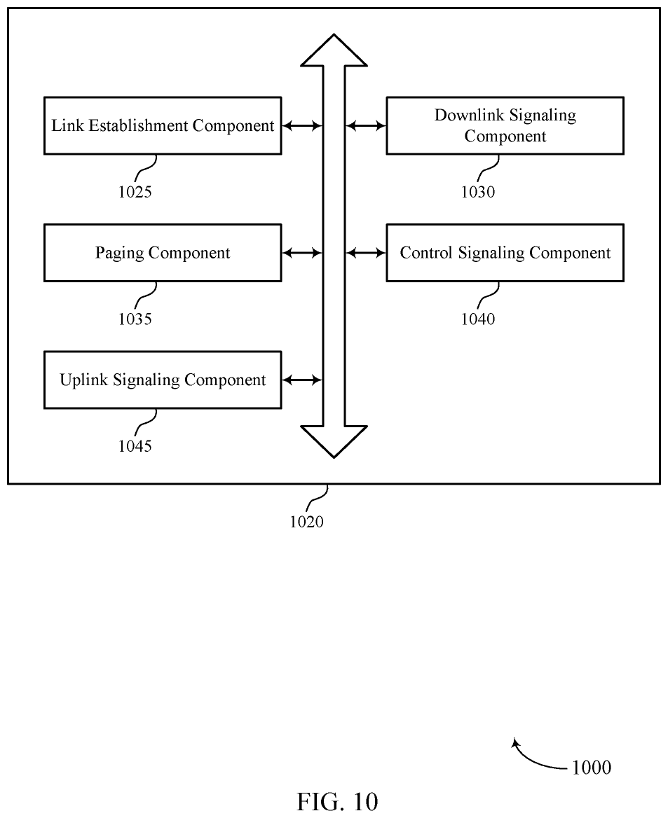

FIG. 10 shows a block diagram 1000 of a communications manager 1020 that supports techniques for paging in an NTN in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for paging in an NTN as described herein. For example, the communications manager 1020 may include a link establishment component 1025, a downlink signaling component 1030, a paging component 1035, a control signaling component 1040, an uplink signaling component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communication in accordance with examples as disclosed herein. The link establishment component 1025 is capable of, configured to, or operable to support a means for establishing a communication link with a UE associated with a TA corresponding to a first cell served by the first NTN entity. The downlink signaling component 1030 is capable of, configured to, or operable to support a means for transmitting data signaling to the UE via the communication link based on the TA. The paging component 1035 is capable of, configured to, or operable to support a means for transmitting paging signaling to the UE via a second NTN entity that serves a second cell corresponding to a set of TAs based on the set of TAs including the TA.

In some examples, to support communicating the paging signaling, the paging component 1035 is capable of, configured to, or operable to support a means for transmitting the paging signaling to the second NTN entity for forwarding to the UE via a second communication link between the UE and the second NTN entity.

In some examples, the control signaling component 1040 is capable of, configured to, or operable to support a means for transmitting control signaling indicating information associated with the second NTN entity including a satellite type of the second NTN entity, one or more resources for communications with the second NTN entity, or one or more locations associated with the second NTN entity, or any combination thereof, where communicating the paging signaling with the UE is based on the control signaling indicating the information associated with the second NTN entity.

In some examples, to support transmitting the control signaling indicating the information associated with the second NTN entity, the control signaling component 1040 is capable of, configured to, or operable to support a means for transmitting a system information block.

In some examples, the first NTN entity includes a non-geostationary orbit satellite. In some examples, the second NTN entity includes a geostationary orbit satellite.

Additionally, or alternatively, the communications manager 1020 may support wireless communication in accordance with examples as disclosed herein. In some examples, the link establishment component 1025 is capable of, configured to, or operable to support a means for establishing a communication link with a UE based on a registration of the UE with the second NTN entity, the UE being associated with a TA. In some examples, the paging component 1035 is capable of, configured to, or operable to support a means for receiving paging signaling from a first NTN entity based on the registration and the first NTN entity serving a first cell corresponding to the TA. In some examples, the paging component 1035 is capable of, configured to, or operable to support a means for transmitting the paging signaling to the UE via the communication link based on the second NTN entity serving a second cell corresponding to a set of TAs including the TA.

In some examples, to support transmitting the paging signaling, the paging component 1035 is capable of, configured to, or operable to support a means for transmitting the paging signaling in at least one paging occasion of a set of paging occasions that at least partially overlaps with one or more paging occasions corresponding to the first NTN entity.

In some examples, to support transmitting the paging signaling, the paging component 1035 is capable of, configured to, or operable to support a means for transmitting the paging signaling in at least one paging occasion of a set of paging occasions that is different than one or more paging occasions corresponding to the first NTN entity.

In some examples, the uplink signaling component 1045 is capable of, configured to, or operable to support a means for receiving uplink signaling from the UE based on transmitting the paging signaling, a quality of service measurement associated with the second NTN entity, or a wireless communication throughput associated with the UE, or any combination thereof.

In some examples, the control signaling component 1040 is capable of, configured to, or operable to support a means for transmitting control signaling indicating one or more parameters including an indication that the first NTN entity or the second NTN entity is a default NTN device, a service type associated with the first NTN entity, a service type associated with the second NTN entity, a service type associated with the first NTN entity and the second NTN entity, or a throughput threshold, or any combination thereof. In some examples, the uplink signaling component 1045 is capable of, configured to, or operable to support a means for receiving uplink signaling from the UE based on transmitting the paging signaling, and the one or more parameters.

In some examples, the control signaling component 1040 is capable of, configured to, or operable to support a means for transmitting control signaling triggering a handover for the UE from the second NTN entity to the first NTN entity based on a service type associated with the UE, a quality of service measurement associated with the second NTN entity, a wireless communication throughput associated with the UE, or a RSRP associated with the first NTN entity, or any combination thereof.

In some examples, transmitting the control signaling is based on the RSRP satisfying the RSRP threshold.

In some examples, the first NTN entity includes a non-geostationary orbit satellite. In some examples, the second NTN entity includes a geostationary orbit satellite.

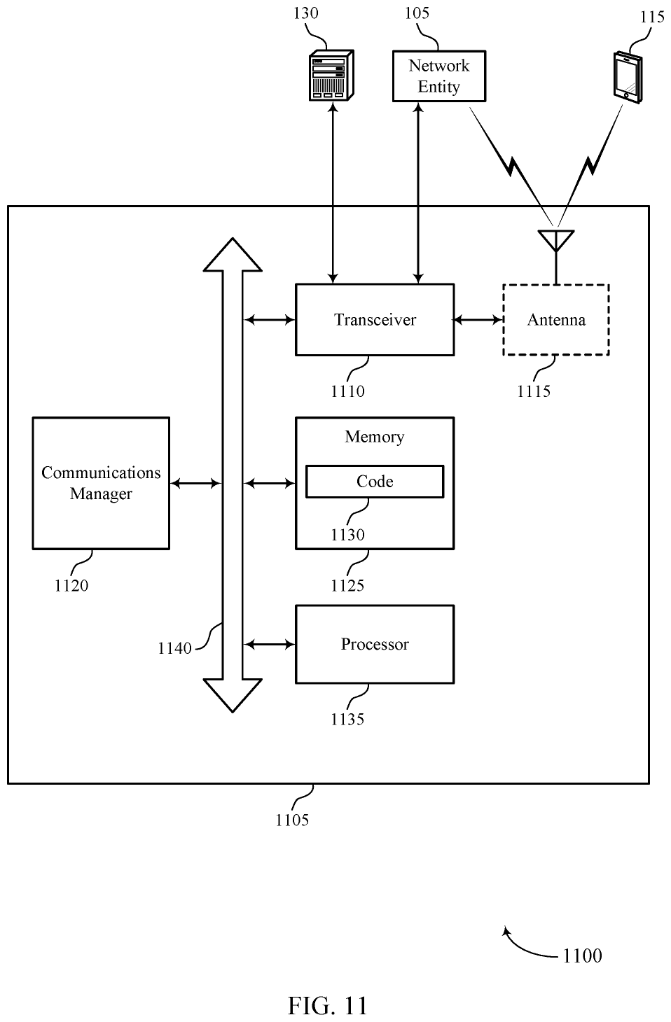

FIG. 11 shows a diagram of a system 1100 including a device 1105 that supports techniques for paging in an NTN in accordance with one or more aspects of the present disclosure. The device 1105 may be an example of or include the components of a device 805, a device 905, or an NTN entity as described herein. The device 1105 may include components for bi-directional voice and data communications including components for transmitting and receiving communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for paging in an NTN). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. As such, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105 and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for establishing a communication link with a UE associated with a TA corresponding to a first cell served by the first NTN entity. The communications manager 1120 is capable of, configured to, or operable to support a means for transmitting data signaling to the UE via the communication link based on the TA. The communications manager 1120 is capable of, configured to, or operable to support a means for transmitting paging signaling to the UE via a second NTN entity that serves a second cell corresponding to a set of TAs based on the set of TAs including the TA.

Additionally, or alternatively, the communications manager 1120 may support wireless communication in accordance with examples as disclosed herein. For example, the communications manager 1120 is capable of, configured to, or operable to support a means for establishing a communication link with a UE based on a registration of the UE with the second NTN entity, the UE being associated with a TA. The communications manager 1120 is capable of, configured to, or operable to support a means for receiving paging signaling from a first NTN entity based on the registration and the first NTN entity serving a first cell corresponding to the TA. The communications manager 1120 is capable of, configured to, or operable to support a means for transmitting the paging signaling to the UE via the communication link based on the second NTN entity serving a second cell corresponding to a set of TAs including the TA.

By including or configuring the communications manager 1120 in accordance with examples as described herein, the device 1105 may support techniques for reduced power consumption and more efficient utilization of communication resources. For example, an NTN entity (e.g., NGSO entity) implementing techniques described herein may perform less TAUs with UEs implementing the techniques described herein, which may conserve power at the NTN entity and utilize less communication resources. Additionally, an NTN entity (e.g., a GSO entity) implementing the techniques described herein may provide for another NTN entity (e.g., an NGSO entity) to perform less TAUs, utilizing less communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for paging in an NTN as described herein, or the at least one processor 1135 and the at least one memory 1125 may be otherwise configured to, individually or collectively, perform or support such operations.

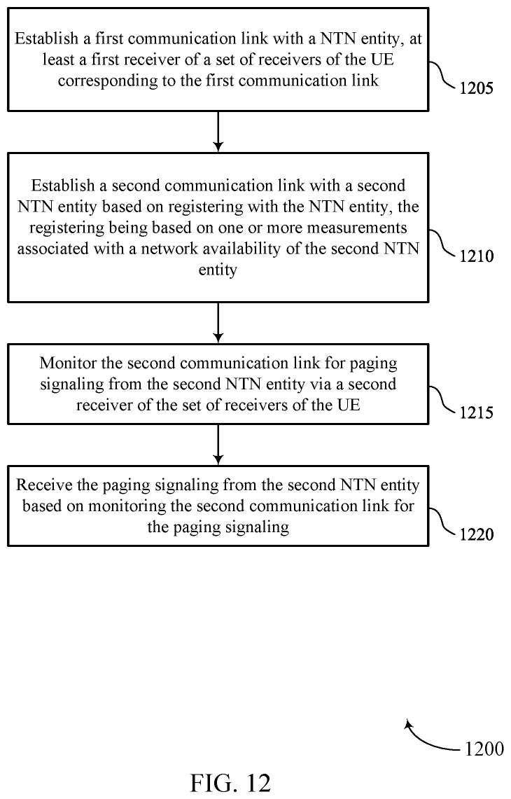

FIG. 12 shows a flowchart illustrating a method 1200 that supports techniques for paging in an NTN in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include establishing a first communication link with a first NTN entity, at least a first receiver of a set of receivers of the UE corresponding to the first communication link. The operations of block 1205 may be performed in accordance with examples as disclosed herein. In some examples, aspects of the operations of 1205 may be performed by a link establishment components 625 as described with reference to FIG. 6.

At 1210, the method may include establishing a second communication link with a second NTN entity based on registering with the second NTN entity, the registering being based on one or more measurements associated with a network availability of the second NTN entity. The operations of block 1210 may be performed in accordance with examples as disclosed herein. In some examples, aspects of the operations of 1210 may be performed by a link establishment components 625 as described with reference to FIG. 6.

At 1215, the method may include monitoring the second communication link for paging signaling from the second NTN entity via a second receiver of the set of receivers of the UE. The operations of block 1215 may be performed in accordance with examples as disclosed herein. In some examples, aspects of the operations of 1215 may be performed by a paging component 630 as described with reference to FIG. 6.

At 1220, the method may include receiving the paging signaling from the second NTN entity based on monitoring the second communication link for the paging signaling. The operations of block 1220 may be performed in accordance with examples as disclosed herein. In some examples, aspects of the operations of 1220 may be performed by a paging component 630 as described with reference to FIG. 6.

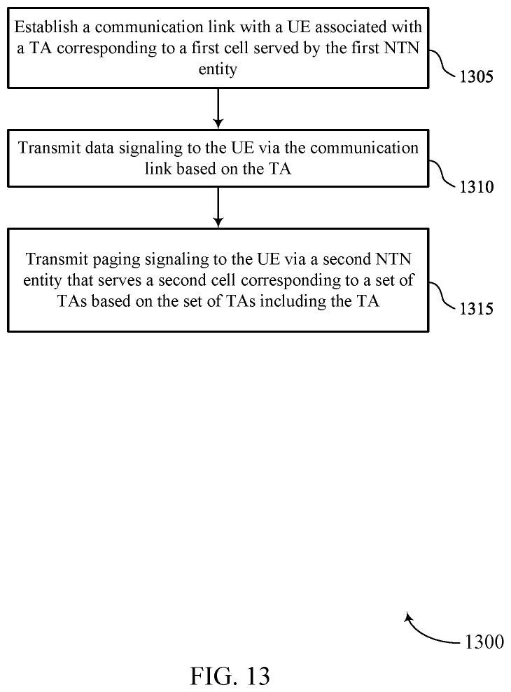

FIG. 13 shows a flowchart illustrating a method 1300 that supports techniques for paging in an NTN in accordance with aspects of the present disclosure. The operations of the method 1300 may be implemented by an NTN entity or its components as described herein. For example, the operations of the method 1300 may be performed by an NTN entity as described with reference to FIGS. 1 through 3 and 8 through 11. In some examples, an NTN entity may execute a set of instructions to control the functional elements of the NTN entity to perform the described functions. Additionally, or alternatively, the NTN entity may perform aspects of the described functions using special-purpose hardware.

At 1305, the method may include establishing a communication link with a UE associated with a TA corresponding to a first cell served by the first NTN entity. The operations of block 1305 may be performed in accordance with examples as disclosed herein. In some examples, aspects of the operations of 1305 may be performed by a link establishment component 1025 as described with reference to FIG. 10.

At 1310, the method may include transmitting data signaling to the UE via the communication link based on the TA. The operations of block 1310 may be performed in accordance with examples as disclosed herein. In some examples, aspects of the operations of 1310 may be performed by a downlink signaling component 1030 as described with reference to FIG. 10.

At 1315, the method may include transmitting paging signaling to the UE via a second NTN entity that serves a second cell corresponding to a set of TAs based on the set of TAs including the TA. The operations of block 1315 may be performed in accordance with examples as disclosed herein. In some examples, aspects of the operations of 1315 may be performed by a paging component 1035 as described with reference to FIG. 10.

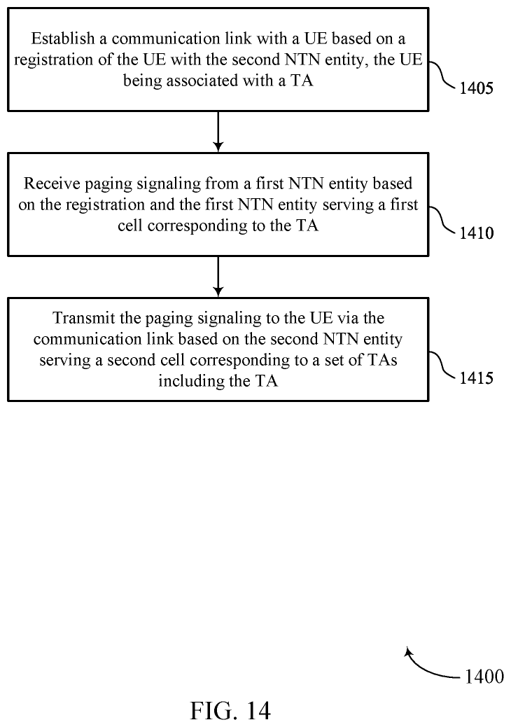

FIG. 14 shows a flowchart illustrating a method 1400 that supports techniques for paging in an NTN in accordance with aspects of the present disclosure. The operations of the method 1400 may be implemented by an NTN entity or its components as described herein. For example, the operations of the method 1400 may be performed by an NTN entity as described with reference to FIGS. 1 through 3 and 8 through 11. In some examples, an NTN entity may execute a set of instructions to control the functional elements of the NTN entity to perform the described functions. Additionally, or alternatively, the NTN entity may perform aspects of the described functions using special-purpose hardware.

At 1405, the method may include establishing a communication link with a UE based on a registration of the UE with the second NTN entity, the UE being associated with a TA. The operations of block 1405 may be performed in accordance with examples as disclosed herein. In some examples, aspects of the operations of 1405 may be performed by a link establishment component 1025 as described with reference to FIG. 10.

At 1410, the method may include receiving paging signaling from a first NTN entity based on the registration and the first NTN entity serving a first cell corresponding to the TA. The operations of block 1410 may be performed in accordance with examples as disclosed herein. In some examples, aspects of the operations of 1410 may be performed by a paging component 1035 as described with reference to FIG. 10.

At 1415, the method may include transmitting the paging signaling to the UE via the communication link based on the second NTN entity serving a second cell corresponding to a set of TAs including the TA. The operations of block 1415 may be performed in accordance with examples as disclosed herein. In some examples, aspects of the operations of 1415 may be performed by a paging component 1035 as described with reference to FIG. 10.

The following provides an overview of aspects of the present disclosure:

Aspect 1: A method for wireless communication at a UE, comprising: establishing a first communication link with a first NTN entity, at least a first receiver of a set of receivers of the UE corresponding to the first communication link; establishing a second communication link with a second NTN entity based at least in part on registering with the second NTN entity, the registering being based at least in part on one or more measurements associated with a network availability of the second NTN entity; monitoring the second communication link for paging signaling from the second NTN entity via a second receiver of the set of receivers of the UE; and receiving the paging signaling from the second NTN entity based at least in part on monitoring the second communication link for the paging signaling.

Aspect 2: The method of aspect 1, further comprising: receiving, via the second communication link, control signaling indicating a set of POs for the paging signaling from the second NTN entity, wherein the set of POs at least partially overlaps with one or more POs corresponding to the first communication link with the first NTN entity, and wherein the monitoring is based at least in part on the control signaling indicating the set of POs.

Aspect 3: The method of aspect 1, further comprising: receiving, via the second communication link, control signaling indicating a set of POs for the paging signaling from the second NTN entity, wherein the set of POs is different than one or more POs corresponding to the first communication link with the first NTN entity, and wherein the monitoring is based at least in part on the control signaling indicating the set of POs.

Aspect 4: The method of any of aspects 1 through 3, further comprising: switching the second receiver from the first communication link to the second communication link, wherein monitoring the second communication link for the paging signaling is based at least in part on the switching.

Aspect 5: The method of any of aspects 1 through 4, further comprising: receiving control signaling indicating information associated with the second NTN entity including a satellite type of the second NTN entity, one or more resources for communications with the second NTN entity, or one or more locations associated with the second NTN entity, or any combination thereof, wherein registering with the second NTN entity is based at least in part on the control signaling indicating the information associated with the second NTN entity.

Aspect 6: The method of aspect 5, wherein receiving the control signaling indicating the information associated with the second NTN entity comprises: receiving a system information block.

Aspect 7: The method of any of aspects 1 through 6, further comprising: performing the one or more measurements associated with the network availability of the second NTN entity, wherein the one or more measurements comprise a public land mobile network search, or decoding one or more NTN measurement configurations broadcasted by the second NTN entity, or both.

Aspect 8: The method of any of aspects 1 through 7, further comprising: storing, in a database, a mapping between one or more locations and the first NTN entity, the second NTN entity, or both, wherein registering with the second NTN entity is based at least in part on the mapping.

Aspect 9: The method of any of aspects 1 through 8, further comprising: transmitting uplink signaling to the first NTN entity or the second NTN entity based at least in part on receiving the paging signaling, a service type associated with the UE, a quality of service measurement associated with the second NTN entity, or a wireless communication throughput associated with the UE, or any combination thereof.

Aspect 10: The method of any of aspects 1 through 9, further comprising: receiving control signaling indicating one or more parameters comprising an indication that the first NTN entity or the second NTN entity is a default NTN device, a service type associated with the first NTN entity, a service type associated with the second NTN entity, a service type associated with the first NTN entity and the second NTN entity, or a throughput threshold, or any combination thereof; and transmitting uplink signaling to the first NTN entity or the second NTN entity based at least in part on receiving the paging signaling and the one or more parameters.

Aspect 11: The method of any of aspects 1 through 10, further comprising: receiving control signaling from the second NTN entity triggering a handover for the UE from the second NTN entity to the first NTN entity based at least in part on a service type associated with the UE, a quality of service measurement associated with the second NTN entity, a wireless communication throughput associated with the UE, or a RSRP associated with the first NTN entity, or any combination thereof; and switching the second receiver from the second communication link to the first communication link based at least in part on receiving the control signaling.

Aspect 12: The method of any of aspects 1 through 11, further comprising: switching the first receiver from the first communication link to the second communication link based at least in part on determining a discontinuous coverage associated with at least the first NTN entity; and monitoring the second communication link for the paging signaling via the first receiver, or the second receiver, or both.

Aspect 13: The method of any of aspects 1 through 12, further comprising: operating in a deep sleep mode for a time duration based at least in part on registering with the second NTN entity, a first mobility associated with the UE satisfying a first mobility threshold, or a second mobility associated with the first NTN entity satisfying a second mobility threshold, or any combination thereof; and transmitting, after the time duration, an indication of a TA associated with the UE based at least in part on a change in the TA.

Aspect 14: The method of any of aspects 1 through 13, wherein registering with the second NTN entity comprises: transmitting control signaling indicating a TA associated with the UE.

Aspect 15: The method of any of aspects 1 through 14, wherein the first NTN entity comprises a NGSO satellite, and the second NTN entity comprises a GSO satellite.

Aspect 16: The method of any of aspects 1 through 15, further comprising: receiving data signaling, control signaling, or both, via the first receiver based at least in part on the first receiver comprising a primary receiver of the UE, wherein the UE receives the paging signaling via the second receiver based at least in part on the second receiver comprising a secondary receiver of the UE.

Aspect 17: A method for wireless communication at a first NTN entity, comprising: establishing a communication link with a UE associated with a TA corresponding to a first cell served by the first NTN entity; transmitting data signaling to the UE via the communication link based at least in part on the TA; and transmitting paging signaling to the UE via a second NTN entity that serves a second cell corresponding to a set of TAs based at least in part on the set of TAs comprising the TA.

Aspect 18: The method of aspect 17, wherein communicating the paging signaling comprises: transmitting the paging signaling to the second NTN entity for forwarding to the UE via a second communication link between the UE and the second NTN entity.

Aspect 19: The method of any of aspects 17 through 18, further comprising: transmitting control signaling indicating information associated with the second NTN entity including a satellite type of the second NTN entity, one or more resources for communications with the second NTN entity, or one or more locations associated with the second NTN entity, or any combination thereof, wherein communicating the paging signaling with the UE is based at least in part on the control signaling indicating the information associated with the second NTN entity.

Aspect 20: The method of aspect 19, wherein transmitting the control signaling indicating the information associated with the second NTN entity comprises: transmitting a system information block.

Aspect 21: The method of any of aspects 17 through 20, wherein the first NTN entity comprises a NGSO satellite, and the second NTN entity comprises a GSO satellite.

Aspect 22: A method for wireless communication at a second NTN entity, comprising: establishing a communication link with a UE based at least in part on a registration of the UE with the second NTN entity, the UE being associated with a TA; receiving paging signaling from a first NTN entity based at least in part on the registration and the first NTN entity serving a first cell corresponding to the TA; and transmitting the paging signaling to the UE via the communication link based at least in part on the second NTN entity serving a second cell corresponding to a set of TAs comprising the TA.

Aspect 23: The method of aspect 22, wherein transmitting the paging signaling comprises: transmitting the paging signaling in at least one PO of a set of POs that at least partially overlaps with one or more POs corresponding to the first NTN entity.

Aspect 24: The method of aspect 22, wherein transmitting the paging signaling comprises: transmitting the paging signaling in at least one PO of a set of POs that is different than one or more POs corresponding to the first NTN entity.

Aspect 25: The method of any of aspects 22 through 24, further comprising: receiving uplink signaling from the UE based at least in part on transmitting the paging signaling, a quality of service measurement associated with the second NTN entity, or a wireless communication throughput associated with the UE, or any combination thereof.

Aspect 26: The method of any of aspects 22 through 25, further comprising: transmitting control signaling indicating one or more parameters comprising an indication that the first NTN entity or the second NTN entity is a default NTN device, a service type associated with the first NTN entity, a service type associated with the second NTN entity, a service type associated with the first NTN entity and the second NTN entity, or a throughput threshold, or any combination thereof; and receiving uplink signaling from the UE based at least in part on transmitting the paging signaling, and the one or more parameters.

Aspect 27: The method of any of aspects 22 through 26, further comprising: transmitting control signaling triggering a handover for the UE from the second NTN entity to the first NTN entity based at least in part on a service type associated with the UE, a quality of service measurement associated with the second NTN entity, a wireless communication throughput associated with the UE, or a RSRP associated with the first NTN entity, or any combination thereof.

Aspect 28: The method of aspect 27, wherein transmitting the control signaling is based at least in part on the RSRP satisfying the RSRP threshold.

Aspect 29: The method of any of aspects 22 through 28, wherein the first NTN entity comprises a NGSO satellite, and the second NTN entity comprises a GSO satellite.

Aspect 30: A UE for wireless communication, comprising one or more memories storing processor-executable code, and one or more processors coupled with the one or more memories and individually or collectively operable to execute the code to cause the UE to perform a method of any of aspects 1 through 16.

Aspect 31: A UE for wireless communication, comprising at least one means for performing a method of any of aspects 1 through 16.

Aspect 32: A non-transitory computer-readable medium storing code for wireless communication, the code comprising instructions executable by one or more processors to perform a method of any of aspects 1 through 16.

Aspect 33: A first NTN entity for wireless communication, comprising one or more memories storing processor-executable code, and one or more processors coupled with the one or more memories and individually or collectively operable to execute the code to cause the first NTN entity to perform a method of any of aspects 17 through 21.

Aspect 34: A first NTN entity for wireless communication, comprising at least one means for performing a method of any of aspects 17 through 21.

Aspect 35: A non-transitory computer-readable medium storing code for wireless communication, the code comprising instructions executable by one or more processors to perform a method of any of aspects 17 through 21.

Aspect 36: A second NTN entity for wireless communication, comprising one or more memories storing processor-executable code, and one or more processors coupled with the one or more memories and individually or collectively operable to execute the code to cause the second NTN entity to perform a method of any of aspects 22 through 29.

Aspect 37: A second NTN entity for wireless communication, comprising at least one means for performing a method of any of aspects 22 through 29.

Aspect 38: A non-transitory computer-readable medium storing code for wireless communication, the code comprising instructions executable by one or more processors to perform a method of any of aspects 22 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
establish a first communication link with a first non-terrestrial network entity, at least a first receiver of a set of receivers of the UE corresponding to the first communication link;
establish a second communication link with a second non-terrestrial network entity based at least in part on registering with the second non-terrestrial network entity, the registering being based at least in part on one or more measurements associated with a network availability of the second non-terrestrial network entity;
monitor the second communication link for paging signaling from the second non-terrestrial network entity via a second receiver of the set of receivers of the UE; and
receive the paging signaling from the second non-terrestrial network entity based at least in part on monitoring the second communication link for the paging signaling.

2. The UE of claim 1, wherein the one or more processors are individually or collectively further operable to execute the code to cause the UE to:
receive, via the second communication link, control signaling indicating a set of paging occasions for the paging signaling from the second non-terrestrial network entity, wherein the set of paging occasions at least partially overlaps with one or more paging occasions corresponding to the first communication link with the first non-terrestrial network entity, and wherein the monitoring is based at least in part on the control signaling indicating the set of paging occasions.

3. The UE of claim 1, wherein the one or more processors are individually or collectively further operable to execute the code to cause the UE to:
receive, via the second communication link, control signaling indicating a set of paging occasions for the paging signaling from the second non-terrestrial network entity, wherein the set of paging occasions is different than one or more paging occasions corresponding to the first communication link with the first non-terrestrial network entity, and wherein the monitoring is based at least in part on the control signaling indicating the set of paging occasions.

4. The UE of claim 1, wherein the one or more processors are individually or collectively further operable to execute the code to cause the UE to:
switch the second receiver from the first communication link to the second communication link, wherein monitoring the second communication link for the paging signaling is based at least in part on the switching.

5. The UE of claim 1, wherein the one or more processors are individually or collectively further operable to execute the code to cause the UE to:
receive control signaling indicating information associated with the second non-terrestrial network entity including a satellite type of the second non-terrestrial network entity, one or more resources for communications with the second non-terrestrial network entity, or one or more locations associated with the second non-terrestrial network entity, or any combination thereof, wherein registering with the second non-terrestrial network entity is based at least in part on the control signaling indicating the information associated with the second non-terrestrial network entity.

6. The UE of claim 5, wherein, to receive the control signaling indicating the information associated with the second non-terrestrial network entity, the one or more processors are individually or collectively operable to execute the code to cause the UE to:
receive a system information block.

7. The UE of claim 1, wherein the one or more processors are individually or collectively further operable to execute the code to cause the UE to:
perform the one or more measurements associated with the network availability of the second non-terrestrial network entity, wherein the one or more measurements comprise a public land mobile network search, or decoding one or more non-terrestrial network measurement configurations broadcasted by the second non-terrestrial network entity, or both.

8. The UE of claim 1, wherein the one or more processors are individually or collectively further operable to execute the code to cause the UE to:
store, in a database, a mapping between one or more locations and the first non-terrestrial network entity, the second non-terrestrial network entity, or both, wherein registering with the second non-terrestrial network entity is based at least in part on the mapping.

9. The UE of claim 1, wherein the one or more processors are individually or collectively further operable to execute the code to cause the UE to:
transmit uplink signaling to the first non-terrestrial network entity or the second non-terrestrial network entity based at least in part on receiving the paging signaling, a service type associated with the UE, a quality of service measurement associated with the second non-terrestrial network entity, or a wireless communication throughput associated with the UE, or any combination thereof.

10. The UE of claim 1, wherein the one or more processors are individually or collectively further operable to execute the code to cause the UE to:
receive control signaling indicating one or more parameters comprising an indication that the first non-terrestrial network entity or the second non-terrestrial network entity is a default non-terrestrial network device, a service type associated with the first non-terrestrial network entity, a service type associated with the second non-terrestrial network entity, a service type associated with the first non-terrestrial network entity and the second non-terrestrial network entity, or a throughput threshold, or any combination thereof; and
transmit uplink signaling to the first non-terrestrial network entity or the second non-terrestrial network entity based at least in part on receiving the paging signaling and the one or more parameters.

11. The UE of claim 1, wherein the one or more processors are individually or collectively further operable to execute the code to cause the UE to:
receive control signaling from the second non-terrestrial network entity triggering a handover for the UE from the second non-terrestrial network entity to the first non-terrestrial network entity based at least in part on a service type associated with the UE, a quality of service measurement associated with the second non-terrestrial network entity, a wireless communication throughput associated with the UE, or a reference signal receive power associated with the first non-terrestrial network entity, or any combination thereof; and
switch the second receiver from the second communication link to the first communication link based at least in part on receiving the control signaling.

12. The UE of claim 1, wherein the one or more processors are individually or collectively further operable to execute the code to cause the UE to:
switch the first receiver from the first communication link to the second communication link based at least in part on determining a discontinuous coverage associated with at least the first non-terrestrial network entity; and
monitor the second communication link for the paging signaling via the first receiver, or the second receiver, or both.

13. The UE of claim 1, wherein the one or more processors are individually or collectively further operable to execute the code to cause the UE to:
operate in a deep sleep mode for a time duration based at least in part on registering with the second non-terrestrial network entity, a first mobility associated with the UE satisfying a first mobility threshold, or a second mobility associated with the first non-terrestrial network entity satisfying a second mobility threshold, or any combination thereof; and
transmit, after the time duration, an indication of a tracking area associated with the UE based at least in part on a change in the tracking area.

14. The UE of claim 1, wherein, to register with the second non-terrestrial network entity, the one or more processors are individually or collectively operable to execute the code to cause the UE to:
transmit control signaling indicating a tracking area associated with the UE.

15. The UE of claim 1, wherein the first non-terrestrial network entity comprises a non-geostationary orbit satellite, and wherein the second non-terrestrial network entity comprises a geostationary orbit satellite.

16. The UE of claim 1, wherein the one or more processors are individually or collectively further operable to execute the code to cause the UE to:
receive data signaling, control signaling, or both, via the first receiver based at least in part on the first receiver comprising a primary receiver of the UE, wherein the UE receives the paging signaling via the second receiver based at least in part on the second receiver comprising a secondary receiver of the UE.

17. A first non-terrestrial network entity, comprising:
one or more memories storing processor-executable code; and
one or more processors coupled with the one or more memories and individually or collectively operable to execute the code to cause the first non-terrestrial network entity to:
establish a communication link with a user equipment (UE) associated with a tracking area corresponding to a first cell served by the first non-terrestrial network entity;
transmit data signaling to the UE via the communication link based at least in part on the tracking area; and
transmit paging signaling to the UE via a second non-terrestrial network entity that serves a second cell corresponding to a set of tracking areas based at least in part on the set of tracking areas comprising the tracking area.

18. The first non-terrestrial network entity of claim 17, wherein, to communicate the paging signaling, the one or more processors are individually or collectively operable to execute the code to cause the first non-terrestrial network entity to:
transmit the paging signaling to the second non-terrestrial network entity for forwarding to the UE via a second communication link between the UE and the second non-terrestrial network entity.

19. The first non-terrestrial network entity of claim 17, wherein the one or more processors are individually or collectively further operable to execute the code to cause the first non-terrestrial network entity to:
transmit control signaling indicating information associated with the second non-terrestrial network entity including a satellite type of the second non-terrestrial network entity, one or more resources for communications with the second non-terrestrial network entity, or one or more locations associated with the second non-terrestrial network entity, or any combination thereof, wherein communicating the paging signaling with the UE is based at least in part on the control signaling indicating the information associated with the second non-terrestrial network entity.

20. The first non-terrestrial network entity of claim 19, wherein, to transmit the control signaling indicating the information associated with the second non-terrestrial network entity, the one or more processors are individually or collectively operable to execute the code to cause the first non-terrestrial network entity to:
transmit a system information block.

21. The first non-terrestrial network entity of claim 17, wherein the first non-terrestrial network entity comprises a non-geostationary orbit satellite, and wherein the second non-terrestrial network entity comprises a geostationary orbit satellite.

22. A second non-terrestrial network entity, comprising:
one or more memories storing processor-executable code; and
one or more processors coupled with the one or more memories and individually or collectively operable to execute the code to cause the second non-terrestrial network entity to:
establish a communication link with a user equipment (UE) based at least in part on a registration of the UE with the second non-terrestrial network entity, the UE being associated with a tracking area;
receive paging signaling from a first non-terrestrial network entity based at least in part on the registration and the first non-terrestrial network entity serving a first cell corresponding to the tracking area; and
transmit the paging signaling to the UE via the communication link based at least in part on the second non-terrestrial network entity serving a second cell corresponding to a set of tracking areas comprising the tracking area.

23. The second non-terrestrial network entity of claim 22, wherein, to transmit the paging signaling, the one or more processors are individually or collectively operable to execute the code to cause the second non-terrestrial network entity to:
transmit the paging signaling in at least one paging occasion of a set of paging occasions that at least partially overlaps with one or more paging occasions corresponding to the first non-terrestrial network entity.

24. The second non-terrestrial network entity of claim 22, wherein, to transmit the paging signaling, the one or more processors are individually or collectively operable to execute the code to cause the second non-terrestrial network entity to:
transmit the paging signaling in at least one paging occasion of a set of paging occasions that is different than one or more paging occasions corresponding to the first non-terrestrial network entity.

25. The second non-terrestrial network entity of claim 22, wherein the one or more processors are individually or collectively further operable to execute the code to cause the second non-terrestrial network entity to:
receive uplink signaling from the UE based at least in part on transmitting the paging signaling, a quality of service measurement associated with the second non-terrestrial network entity, or a wireless communication throughput associated with the UE, or any combination thereof.

26. The second non-terrestrial network entity of claim 22, wherein the one or more processors are individually or collectively further operable to execute the code to cause the second non-terrestrial network entity to:
transmit control signaling indicating one or more parameters comprising an indication that the first non-terrestrial network entity or the second non-terrestrial network entity is a default non-terrestrial network device, a service type associated with the first non-terrestrial network entity, a service type associated with the second non-terrestrial network entity, a service type associated with the first non-terrestrial network entity and the second non-terrestrial network entity, or a throughput threshold, or any combination thereof; and
receive uplink signaling from the UE based at least in part on transmitting the paging signaling, and the one or more parameters.

27. The second non-terrestrial network entity of claim 22, wherein the one or more processors are individually or collectively further operable to execute the code to cause the second non-terrestrial network entity to:
transmit control signaling triggering a handover for the UE from the second non-terrestrial network entity to the first non-terrestrial network entity based at least in part on a service type associated with the UE, a quality of service measurement associated with the second non-terrestrial network entity, a wireless communication throughput associated with the UE, or a reference signal receive power associated with the first non-terrestrial network entity, or any combination thereof.

28. The second non-terrestrial network entity of claim 27, wherein transmitting the control signaling is based at least in part on the reference signal receive power satisfying the reference signal receive power threshold.

29. The second non-terrestrial network entity of claim 22, wherein the first non-terrestrial network entity comprises a non-geostationary orbit satellite, and wherein the second non-terrestrial network entity comprises a geostationary orbit satellite.

30. A method for wireless communication at a user equipment (UE), comprising:
establishing a first communication link with a first non-terrestrial network entity, at least a first receiver of a set of receivers of the UE corresponding to the first communication link;
establishing a second communication link with a second non-terrestrial network entity based at least in part on registering with the second non-terrestrial network entity, the registering being based at least in part on one or more measurements associated with a network availability of the second non-terrestrial network entity;
monitoring the second communication link for paging signaling from the second non-terrestrial network entity via a second receiver of the set of receivers of the UE; and
receiving the paging signaling from the second non-terrestrial network entity based at least in part on monitoring the second communication link for the paging signaling.
